(19) United States
(12) Patent Application Publication
(10) Pub. No.: US 2024/0095682 A1
(43) Pub. Date: Mar. 21, 2024

(54) SYSTEM AND METHODS FOR MANAGING SCHEDULES AND CALENDARS

(71) Applicant: Reclaim Inc., Portland, OR (US)

(72) Inventors: Patrick Lightbody, Portland, OR (US); Henry Shapiro, Portland, OR (US)

(21) Appl. No.: 18/516,359

(22) Filed: Nov. 21, 2023

Related U.S. Application Data
(63) Continuation-in-part of application No. 17/838,098, filed on Jun. 10, 2022.
(60) Provisional application No. 63/209,864, filed on Jun. 11, 2021.

(51) Int. Cl. G06Q 10/1093

(52) U.S. Cl. CPC G06Q 10/1095

(57) ABSTRACT

Calendar management devices and systems are disclosed that are configured to receive one or more user events for scheduling with a digital calendar associated with a user, retrieve metadata for each of the one or more user events, determine priority information associated with each of the one or more user events by checking the metadata for each of the one or more user events, and automatically schedule each of the one or more user events based on the priority information for each of the one or more user events.

### CROSS-REFERENCE TO RELATED APPLICATIONS

The application is a continuation-in-part application of the U.S. patent application Ser. No. 17/838,098 filed Jun. 10, 2022, and entitled “SYSTEM AND METHODS FOR MANAGING SCHEDULES AND CALENDARS,” which claims the benefit of and priority to U.S. Provisional Application No. 63/209,864 filed Jun. 11, 2021, and entitled “SYSTEM AND METHODS FOR MANAGING SCHEDULES AND CALENDARS,” the content of each of which is hereby incorporated by reference in its entirety.

### TECHNICAL FIELD

The present disclosure relates to calendar and event organization software applications, and more particularly to an intelligent calendar and schedule managing system and method that integrates disparate sets of data to identify scheduling priorities and conflicts and automatically generates scheduling suggestions for digital calendars.

### BACKGROUND

Currently, people are frequently facing the task of scheduling meetings, appointments, and other events using scheduling applications (e.g., Microsoft Office Outlook, Google Calendar, Zoom Events), especially after the introduction of remote collaboration technologies like videoconferencing and Slack, which facilitate remote or hybrid work. Businesses and organizations across a large variety of fields now more frequently use virtual or digital calendars (software application-based calendars) to schedule videoconference meetings and various resources such as professional staff, equipment (e.g., medical instruments), and rooms (e.g., conference rooms), especially after the start of the COVID 19 pandemic.

Digital calendars such as Microsoft Office Outlook and Google Calendar have aided in the scheduling of events, meetings, and various resources, and their popularity has largely prototyped the look-and-feel, function, and usability of the existing calendar and scheduling systems. For example, the traditional task of scheduling an event consists of checking available time slots within a digital or virtual calendar, selecting the desired time slot, and entering various information for the event using one or more user interfaces (e.g., windows and/or views), and then submitting the event for publishing to the digital or virtual calendar. Once the event has been published, the event appears relative to the time slot in which the event coincides.

However, these existing digital calendars or calendaring platforms are generally stuck on the same basic fundamentals, that is, entries in these calendar databases are rigid and constrained to a fixed start/end time and either fully free or fully busy. But in real applications, especially in work environments, people negotiate and adjust their availability all the time, depending on the shifting priorities, among others. The existing digital calendars cannot handle these scenarios in an efficient manner. For example, with busier schedules on everyone's calendar due to the popularity of remote and hybrid work, it is often burdensome to find an ideal time slot to cater to all participants for a videoconference in the existing calendar platforms, which becomes even more worrisome when a scheduled event needs to be rescheduled. For example, a person may find himself/herself taking more than half an hour to email or message participants back and forth to find a time slot that caters to all participants.

In an era of rapid artificial intelligence (AI)/machine learning (ML) innovation, it is imperative that scheduling services level-up beyond the limitations of today's calendar platforms. Although large language models are advancing fast, no such models or other AI/ML models have been developed to directly optimize scheduling services. Therefore, there is a need for a better scheduling or calendar software application for more efficient calendar and event organization.

### SUMMARY

To address the aforementioned shortcomings, a method and system for intelligent calendar and event organization are provided.

In one aspect, a system for intelligent calendar management includes a processor, and a memory, coupled to the processor, configured to store executable instructions. The instructions, when executed by the processor, cause the processor to receive one or more user events for scheduling with a digital calendar associated with a user, retrieve metadata for each of the one or more user events, determine priority information associated with each of the one or more user events by checking the metadata for each of the one or more user events, and automatically schedule each of the one or more user events based on the priority information for each of the one or more user events.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to embodiments that solve any or all disadvantages noted in any part of this disclosure.

### BRIEF DESCRIPTION OF THE DRAWINGS

The drawing figures depict one or more embodiments in accordance with the present teachings, by way of example only, not by way of limitation. In the figures, like reference numerals refer to the same or similar elements. Furthermore, it should be understood that the drawings are not necessarily to scale.

FIG. 1 illustrates a block diagram of an example intelligent calendar system, according to embodiments of the disclosure.

FIG. 2 illustrates a block diagram of an example architecture of an intelligent calendar application, according to embodiments of the disclosure.

FIG. 3A illustrates an example user interface for displaying interactive components of an intelligent calendar, according to some embodiments.

FIG. 3B illustrates an example user interface for customizing a habit for a calendar, according to embodiments of the disclosure.

FIG. 3C illustrates an example ID for an event, according to some embodiments of the disclosure.

FIG. 4 is a flow chart of an example method for scheduling a habit, according to embodiments of the disclosure.

FIG. 5A illustrates an example user interface for prebuilt habits for a calendar, according to embodiments of the disclosure.

FIG. 5B illustrates an example user interface for customizing a lunch schedule, according to embodiments of the disclosure.

FIG. 5C illustrates example user interfaces generated in a scheduling process, according to embodiments of the disclosure.

FIG. 6 is a flow chart of an example method for scheduling a task, according to embodiments of the disclosure.

FIG. 7A illustrates an example user interface for converting a 1:1 meeting in a conventional calendar to a smart 1:1 meeting, according to embodiments of the disclosure.

FIG. 7B illustrates an example user interface for scheduling a 1:1 meeting, according to embodiments of the disclosure.

FIG. 8 is a flow chart of an example method for synchronizing calendars, according to embodiments of the disclosure.

FIG. 9A illustrates a set of example user interfaces in synchronizing calendars, according to embodiments of the disclosure.

FIG. 9B illustrates another set of example user interfaces in synchronizing calendars, according to embodiments of the disclosure.

FIG. 9C illustrates a set of example user interfaces in synchronizing calendars and integrating events from other platforms, according to embodiments of the disclosure.

FIG. 9D illustrates example user interfaces for toggling the priority of events in a calendar, according to embodiments of the disclosure.

FIG. 9E illustrates an example user interface for showing the status of a user in Slack, according to embodiments of the disclosure.

FIG. 10 is a flow chart of an example method for scheduling one or more events based on priority information of the events, according to some embodiments.

### DETAILED DESCRIPTION

In the following detailed description, numerous specific details are set forth by way of examples in order to provide a thorough understanding of the relevant teachings. However, it should be noted that the present teachings may be practiced without such details. In other instances, well-known methods, procedures, components, and/or circuitry have been described at a relatively high level, without detail, in order to avoid unnecessarily obscuring aspects of the present teachings. The headings provided herein are for convenience only and do not necessarily affect the scope or meaning of the claims.

Information technology infrastructure is changing as storage, processing, and networking become more distributed. The migration of many computer resources to distributed networks using servers that are hosted by a service provider is becoming prevalent in many business sectors. Those distributed networks can be standalone networks where all the computation and processing is done by the hosted provider with a simple communications terminal for input or it can be a hybrid of local processing along with distributed processing. Distributed processing systems typically include banks of hardware and software servers that are either owned for proprietary use or leased to clients for use from minutes or hours to long-term leases lasting years.

Cost considerations are important for all aspects of distributed computing including processing power and reliability through redundancy, storage capability, and reliability through redundancy, and available short and long-distance network bandwidth. Increased demand for storage, processing power, and network bandwidth results in increased cost. It is thus imperative that computing service users/clients find ways to remain competitive and it is clear that using computing resources appropriately is a material component of remaining competitive.

Current practices in calendar and event organizations for many providers do not optimize computing resources. The process requires multiple mouse clicks, generation of user interfaces (UIs), monitoring and tracking of user inputs, etc., which require the processing by the processor and network data transmissions with significant latency and consumption of computing resources at each step. For instance, in existing calendar and event organization platforms, the creation of a calendar entry, such as a reservation for a service (e.g., a conference room, a class, and the like), is largely duplicative and time-consuming for users. To make matters worse, the task of creating calendar entries, or modifying existing calendar entries, is often complicated by a large number of required fields and confusing and flawed interfaces.

Aspects and embodiments disclosed herein present intelligent calendar systems and methods that direct the creation of calendar entries in a manner that is simpler and more efficient than other existing calendars and event organization platforms by leveraging the advancements in AI/ML technology. For example, the intelligent calendar systems disclosed herein may include a machine learning algorithm that determines to schedule events with complex frequencies by learning from the previous scheduling patterns for similar events from a same user or a large number of calendars of different users. For another example, the intelligent calendar systems disclosed herein may also include a machine learning algorithm that automatically identifies the assignment event categories, so as to automatically schedule events based on the identified event categories. The intelligent calendar systems may also include other ML/AI mechanisms for automation of calendar scheduling without requiring many user inputs.

In some embodiments, the scheduling algorithms of the disclosed intelligent calendar systems disclosed herein may further leverage some baseline metadata associated with events in scheduling. In one embodiment, metadata may be configured to define and/or utilized to identify which events are and are not under control of an automated scheduler, to increase the scheduling flexibility. In another embodiment, metadata may be also configured to define and/or identify a coarse-grained priority level and/or a fine-tuned priority sublevel for an associated event. In some embodiments, the information defined through metadata may be further retrieved and utilized by the disclosed intelligent calendar systems to automatically schedule events according to the priority information of each event.

The intelligent calendar system disclosed herein shows technical improvements when compared to other existing calendar and event organization platforms. First, as a smart calendar tool, the disclosed intelligent calendar system automatically finds the best time for a user's tasks, habits, breaks, and one-on-one meetings around the user's existing and evolving schedule. This productive application saves time and computing resources through flexible and adaptive time blocking, automating the gap between endless to-dos and the user's calendar. Second, the disclosed intelligent calendar system allows a user to defend the user's time by integrating the task lists from different project management apps (e.g., ClickUp, Todoist, Asana, Jira, Linear, Google Tasks), to automatically schedule time for the user's to-dos, and set up recurring smart time blocks for daily routines. Third, the disclosed intelligent calendar system automatically organizes a user's schedule around which tasks or routines are the highest priority for the user, and auto-schedule events based on priorities of the events and/or auto-reschedule when priorities change. Fourth, the disclosed intelligent calendar system simplifies communications by auto-scheduling recurring one-on-one meetings with Smart 1:1 s, so a user never has to waste computing resources going through the calendar application/app back-and-forth.

Overall, relying on the processor to suggest appropriate schedules such that the computing resources can be reduced by as much as a factor of ten by automatically finding the best time for tasks and automatically scheduling and organizing a user's schedule typically manually selected sequentially, thereby reducing computing power and network bandwidth requirements. The efficiency gain in computing resources is especially important to local onsite systems (e.g., mobile devices) that are generally more power-stringent. These improvements in computing resources scale accordingly as the data sets and features become larger.

The benefits and advantages described herein are not all-inclusive and many additional features and advantages will be apparent to one of ordinary skill in the art in view of the figures and the following descriptions.

### Overview of Intelligent Calendar System

As used herein, the term “calendar” is to be interpreted according to its broad and ordinary meaning and may refer to a calendaring software application, a calendar object or data type, or any other software and/or hardware representation of calendar data, or software and/or hardware utilized in connection therewith. The term “object” is used herein according to its broad and ordinary meaning and may refer to any type of data structure or data type having one or more parameters associated therewith.

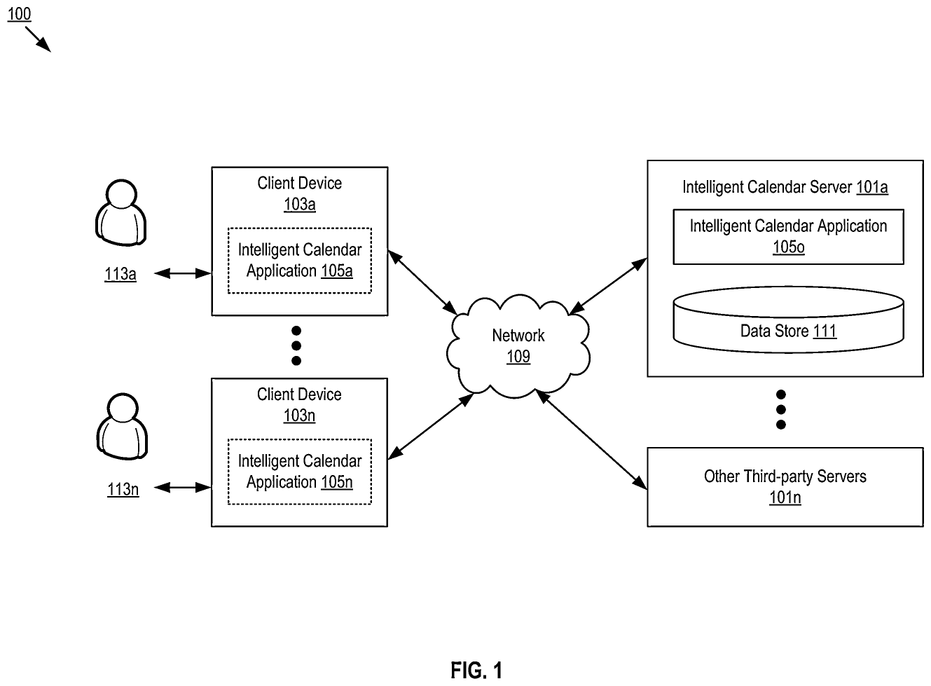

FIG. 1 illustrates a block diagram of an example intelligent calendar system 100, according to embodiments of the disclosure. In the illustrated embodiment, the intelligent calendar system 100 can take the form of hardware and/or software components running on hardware. For example, in the intelligent calendar system 100, certain software (e.g., applications or apps, operational instructions, modules, etc.) may be run on a processing device, such as a computer, mobile device (e.g., smartphone, smartwatch, tablet, laptop, personal digital assistant (PDA)) and/or any other electronic device. In some embodiments, the components of the intelligent calendar system 100 may be distributed across and executable by multiple devices. For example, an input may be entered on a client device, and information may be processed or accessed from other devices (e.g. servers or other client devices) in a network.

As illustrated in FIG. 1, an intelligent calendar system 100 may include distributed client devices 103a-103n (collectively or individually referred to as client device 103), network 109, and a server environment comprising one or more servers, including but not limited to intelligent calendar server 101a and one or more third-party servers 101n. Each client device 103 may be associated with a user 113a or 113n (collectively or individually referred to as user or individual 113). One skilled in the art will appreciate that the scale of intelligent calendar system 100 may vary and may include additional or fewer components than those illustrated in FIG. 1. In some embodiments, interfacing between components of the intelligent calendar system 100 may occur remotely, for example, where the components of the intelligent calendar system 100 may be distributed across one or more devices of a distributed network.

Client device 103 may be configured to receive input from a user 113 via a user interface component or other input means. Examples of input may include voice, visual, touch, or text input, etc. In some embodiments, one or more portions of the input may correspond to a task or habit customization, event description, event decoration, event publication, and other calendar-related activities within a digital calendar. Client device 103 may store the calendar-related activities including the created calendars as calendar data. In some embodiments, the client device 103 may also collect and store other user information not necessarily received from the user inputs. For example, client device 103 may be configured to automatically track user locations, user online activities, or other user activities implemented on or accessible through the client device 103. For instance, based on the tracked location information, the client device 103 may determine when a user 113 arrives at and gets off from the office, or when a user takes a walk during business hours or after business hours. Based on the determined location information, the intelligent calendar system 100 may determine a proper schedule that fits the current location of the user.

In some embodiments, the client device 103 may also provide access to data sources comprising the calendar data or other user information associated with a user 113. In some embodiments, the data sources may be located on, or accessible to, the intelligent calendar server 101a and/or other third-party servers 101n via a network 109. As an example, the data sources may be locally stored on a client device 103, or may be locally or remotely stored on one or more of the intelligent calendar server 101a (e.g., in the data store 111 coupled to the intelligent calendar server 101a) and/or other third-party servers 101n.

As illustrated in FIG. 1, each client device 103 may further include a respective intelligent calendar application 105a or 105n. The intelligent calendar server 101a may include a repository of calendar and/or user data as well as an instance of intelligent calendar application 105o (105a . . . 105o together or individually referred to as intelligent calendar application 105). The calendar and/or user data repository or data store 111 and/or the intelligent calendar application 105o may reside on a single server or may be spread across multiple servers, as desired or practical. The intelligent calendar server 101a may be implemented according to executable code and/or associated server components used to support computing on server 101a. The data store 111 may include one or more non-transitory computer-readable media, and may collectively comprise logical data, executable code, instructions, and/or associated components to support storage, data management, and retrieval of the calendar and/or user data. The calendar and/or user data may comprise calendar information consisting of one or more of various data structures or data types. For example, calendar data may comprise one or more calendar objects or data structures incorporating various calendar-related parameter(s), and/or calendar event objects or data structures incorporating event-related parameter(s).

Intelligent calendar server 101a may be a cloud server that possesses larger computing/communication capabilities and computing resources than a client device 103, and therefore may perform more complex computations or communications than the client device 103 can. For example, a complicated decision process for automatically determining an ideal time slot for an event and automatically blocking the time slot for the event may be implemented in the instance of the intelligent calendar application 105o on the intelligent calendar server 101a, while a receiving of user input to block a time slot may be implemented in the instance of the intelligent calendar application 105a or 105n on a client device 103. For another example, the intelligent calendar application 105o of the intelligent calendar server 101a may automatically perform complex calendar synchronization or event integration by communicating with other third-party servers 101n, which then prevents a client device 103 from receiving a series of mouse clicks by the user, generating user interfaces (UIs), and monitoring and tracking user input to schedule a task or event through the client device 103. The above functions of the intelligent calendar server 101a together can redistribute the majority, if not all, of event scheduling from a client device 103 to the cloud server 101a, which then greatly reduces the consumption of computing resources, network bandwidth, and power of the client device, thereby greatly improving the performance and lifetime of the client device 103.

In some embodiments, the intelligent calendar server 101a may be further configured to facilitate calendar information communication between the client devices 103, and possibly other third-party servers (s) 101n. For example, client devices 103 may exchange calendar information via the intelligent calendar server 101a over the network 109, directly between client devices 103 via the network 109, and/or through direct device-to-device information exchange, such as over a local pairing or network connection (e.g., Bluetooth, near-field communication, infrared, etc.).

Other third-party servers 101n may be provided using other logical server instances or included with the intelligent calendar server 101a according to some embodiments. The third-party servers 101n may provide additional services to the intelligent calendar server 101a, or the services may be provided directly to the client devices 103. Server features and services may be related to calendar information processing and/or other context-driven features. Examples of other server services may include, but are not limited to, certain other calendar or event management platforms (e.g., Zoom, Slack), video videoconferencing features, document collaboration, and the like. In some embodiments, third-party servers 101n may also provide additional services or data to the client devices 103. Examples include but are not limited to map/navigation and traffic services, advertising/marketing services, local weather/news information alerts, and/or other services.

Network 109 may be a conventional type, wired and/or wireless, and may have numerous different configurations, including a star configuration, token ring configuration, or other configurations. For instance, the network 109 may include one or more local area networks (LAN), wide area networks (WAN) (e.g., the Internet), public networks, private networks, virtual networks, mesh networks, peer-to-peer networks, and/or other interconnected data paths across which multiple devices may communicate. The network 109 may also be coupled to or include portions of a telecommunications network for sending data in a variety of different communication protocols. In some embodiments, the network 109 includes Bluetooth communication networks or a cellular communications network for sending and receiving data including via short messaging service (SMS), multimedia messaging service (MMS), hypertext transfer protocol (HTTP), direct data connection, wireless application protocol (WAP), email, etc. In some embodiments, during data transmission in calendar creation and/or update, certain security mechanisms may be implemented in network 109, to ensure no user information is leaked during data transmission between the client devices 103 and/or the servers 101.

### Architecture for Intelligent Calendar System

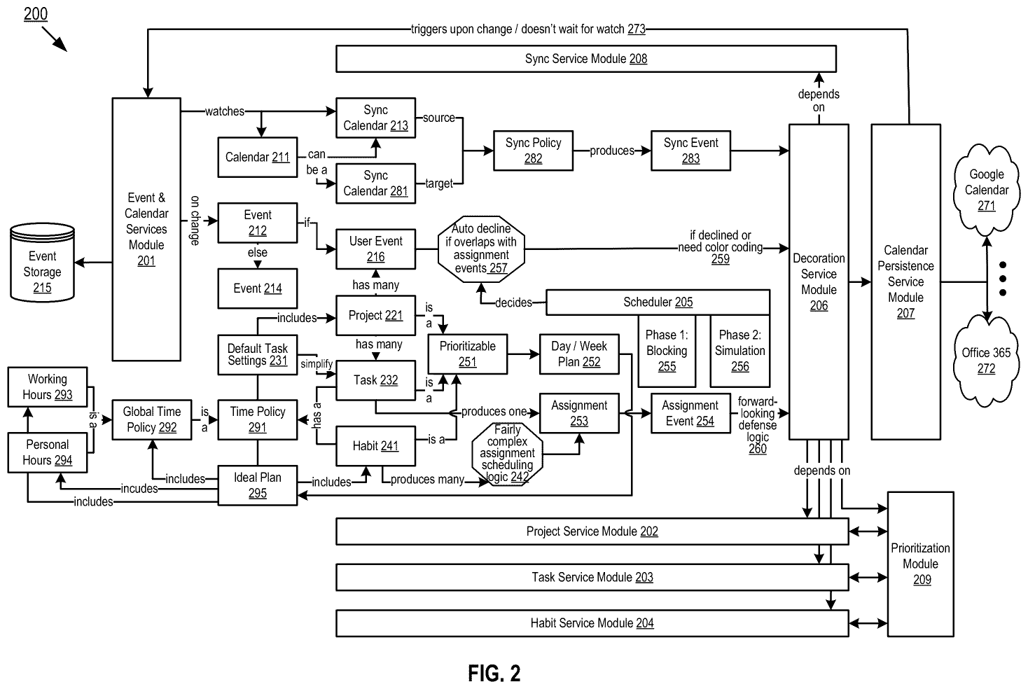

FIG. 2 illustrates a block diagram of an architecture 200 for an example embodiment including various design concepts and aspects of the intelligent calendar system 100 of the present disclosure. The architecture of FIG. 2 is designed to provide a cross-platform and cross-application solution that can support and work with a plurality of different applications, services, devices, and systems. Architecture 200, in some embodiments, may provide an alternative to other existing device calendars and personal information management and organization applications and functions. In some embodiments, the architecture 200 may interface and support one or more applications using one or more communication protocols and techniques.

In some embodiments, the various design concepts and aspects of the architecture 200 may be implemented by different functional modules included in the intelligent calendar application 105. According to one embodiment, the architecture of FIG. 2 may include an event & calendar services module 201, a project service module 202, a task service module 203, a habit service module 204, a scheduler 205, a decoration service module 206, a calendar persistence service module 207, and a sync service module 208.

The event & calendar services module 201 may be configured to monitor a calendar 211 and one or more events 212 within the calendar. For example, the event & calendar module 201 may check whether there is any new event or update of an existing event included in the calendar 211. In response to a detected change of a new event or existing event update, the event & calendar services module 201 may further modify certain information associated with the calendar. For example, the event & calendar services module 201 may store the new event or updated event in the event storage 215 coupled to the event & calendar services module 201.

Calendar 211 monitored by the event & calendar services module 201 may be an intelligent calendar generated by the disclosed intelligent calendar system 100 or a calendar planner coupled to other existing calendars or event organization platforms. For example, calendar 211 may be an intelligent calendar that can receive a user request to schedule certain events, automatically schedule or reschedule certain events upon request, automatically add a buffer event, automatically decline or defend certain events, etc. According to one embodiment, the intelligent calendar 211 may be fixed to be the primary calendar of an authenticated user, and thus allow to determine the availability of the user.

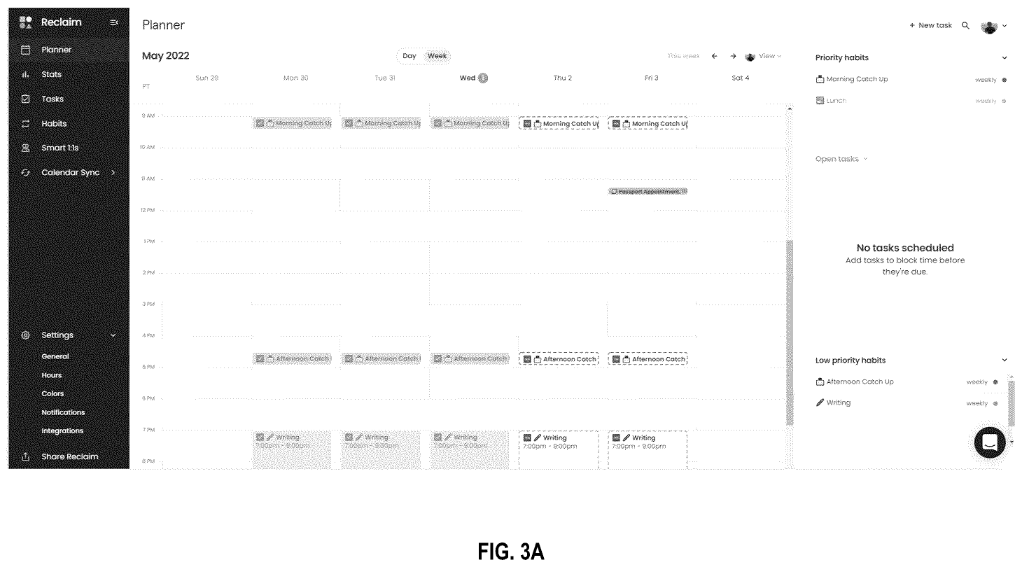

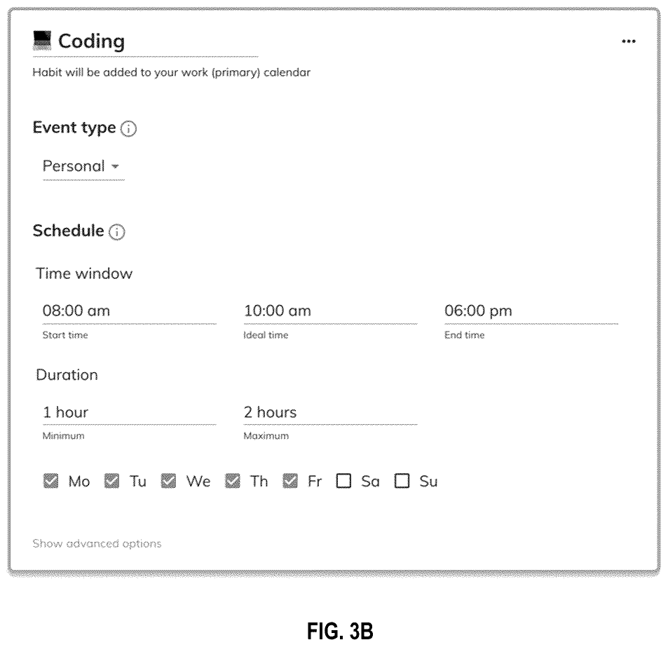

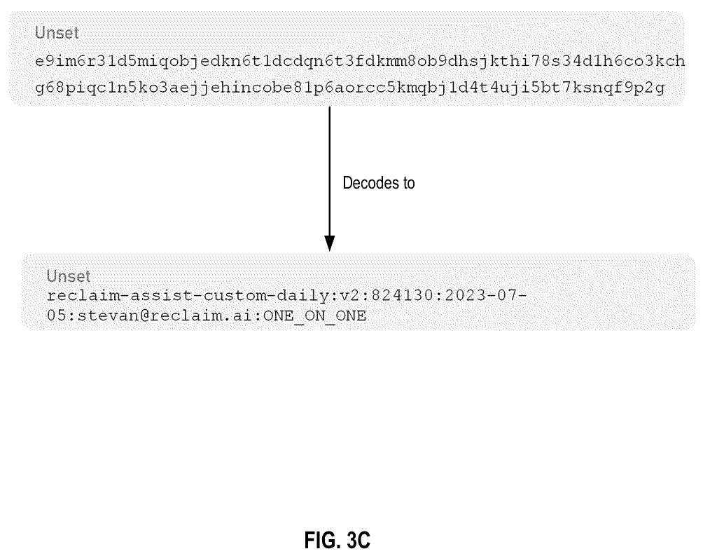

In some embodiments, calendar 211 may be displayed in a user interface like a conventional calendar that lists events in a day, week, or month format. One example user interface is shown in FIG. 3A, which includes an intelligent calendar marked as a “planner”. As shown in the figure, the user interface for displaying the calendar 211 may include interactive links that allow a further review of certain information associated with the calendar 211. For example, the user interface may provide links to allow a quick review of the tasks, habits, or smart one-to-one meetings (1:1 meetings or 1:1s) for the current day, week, or month. In some embodiments, the user interface may provide links to allow a quick review of the statistics of the calendar. For example, the statistics of the calendar displayed in the user interface may include data for work statistics (e.g., free time, meeting time, shallow solo work, deep solo work, etc.), life statistics (e.g., personal time, travel time, vacation time, etc.), task statistics (e.g., overdue, active, completed, task time, etc.), habits statistics (e.g., morning catch up, afternoon catch up, reading, etc.), or other statistical data. In some embodiments, the user interface for the calendar may generate two different views, one for the owner and the other for others, and the user interface may allow the owner of the calendar to quickly switch between the two views. In some embodiments, the user interface may also include settings to allow a user to set up default task settings, buffer time settings (including task duration, event duration, start delay, and due date), settings for working hours, personal hours, and meeting hours, and color settings. Additional interactive links may include but are not limited to smart 1:1s, calendar sync, integration, share the application, priority habits, lower priority habits, and open tasks. These interactive links will be described more in detail with reference to respective components.

The events 212 included in the calendar 211 may have certain event properties set up by the authorized user associated with the calendar. For example, the user may set up the title, summary description, privacy, visibility, color, notification, attendees, and the like for an event. The title and/or summary description may provide a brief description of an event, allowing quick identification of the event. For example, the title for an event may be “lunch with John.” The privacy of an event may be set as public, private, or default. A public event may allow others to see the event. A private event may be not visible to others, while an event set as default can be either public or private depending on how the system or the user sets up the default settings. The visibility sets up the information visibility to others when an event is a public event. For example, an event may be set to be “busy”, “personal commitment” or may be set to allow others to see more detailed information (e.g., title and/or brief description) about the event. The color of an event may be a classification of the event type. By presenting events within the calendar 211 in color, it may allow a user to get a quick review of the types of events in his/her calendar. In one example, the color scheme for different event types may follow a color scheme used by other existing applications, such as Google Calendar or Office 365. The event notification may be set to default. For example, each event may be notified at a certain amount of time (e.g., 5 min, 10 min, 15 min, etc.) ahead of the event. In some embodiments, the notification settings may specifically define when a user does not want to be notified of an event. For example, for certain events such as daily habits, a user may get used to the schedule for these habits, and thus notification settings may define when a user does not want to be notified for such habits. Attendees for an event may define the participants for the event. For example, for a habit, setting up the attendees may allow copying the habit settings to other attendees.

In some embodiments, besides monitoring events created through the intelligent calendar system (e.g., events created through the intelligent calendar system), the event & calendar services module 201 may also monitor certain user events 216 not created by the intelligent calendar system 100. These user events 216 may occur in the intelligent calendar 211 through integration or other possible means (e.g., user events shared by others or user events that occurred in the calendar 211 due to the assignments from a project 221 as will be described later). These user events 216 not created through the intelligent calendar system may require nominal control by the intelligent calendar system 100, such as color-coding, RSVP (“please respond”) (e.g., accept or decline if not auto-declined), or rescheduling (e.g. if overlapping with existing events in the intelligent calendar 211).

In some embodiments, the events (e.g., events 214) created by the intelligent calendar 211 may be synchronized to other calendars or event organization platforms associated with the user. For example, a new event created through the intelligent calendar system 100 may be synchronized to other calendars or event organization platforms, such as Todoist, Slack, Google Tasks, etc. Accordingly, the intelligent calendar 211 may serve as a source calendar 213 during calendar synchronization, as illustrated in FIG. 2. This allows events in the intelligent calendar 213 to be synchronized to a target sync calendar 281. In some embodiments, the calendar 211 can also be a target calendar 281 during the calendar synchronization. For example, events that occur in other calendars or event organization platforms may be added to the intelligent calendar 211 through calendar synchronization. Detail description regarding the calendar synchronization will be described more in detail with reference to the sync service module 208.

Referring back to FIG. 2, the architecture 200 may include a project service module 202 that is configured to manage the project timeline through the intelligent calendar system 100. A project 221 may be an undertaking to be carried out individually or collaboratively to achieve a particular aim. For example, a project 221 may seek the realization of a unique and innovative deliverable, such as a product, a service, a process, or in some cases, scientific research by an individual or organization. Project 221 has a beginning and an end and is considered as a closed dynamic system bound by certain constraints such as calendar, costs, and norms of quality. A project is a driven force for creating tasks or events for an individual or organization. As illustrated in FIG. 2, a project 221 may include a certain number of user events 216 and tasks 232, completion of which allows achievement of the particular aim of the project 221.

In some embodiments, the intelligent calendar system 100 may generate a user interface to allow the organizer to determine the timeline (e.g., due date) of each task included in the project. In some embodiments, the organizer may also define certain user events 216 that are not necessarily driven by the specific tasks 232. For example, the organizer may expect each department leader to meet once a week, and thus certain user events 216 such as weekly meetings may be generated by the organizer through the intelligent calendar system 100. The generated user events may be delivered to each individual's calendar by the project service module 202, which may allow the corresponding member to RSVP to the user events, e.g., to accept or decline a user event. If accepted, user event 216 related to project 221 may occur in the member's calendar 211. If the user event 216 has a conflict with the member's calendar, e.g., overlaps with the assignment events in the calendar, the user event 216 may be auto-declined or require a reschedule, as indicated by the block 257 in FIG. 2.

In some embodiments, the project service module 202 may monitor the whole process of the project by communicating with the intelligent calendars of the respective parties. For instance, events or specific tasks of project 221 may be marked as “finished” by the intelligent calendars of the respective parties, which then allows the overall progress of the project to be monitored. If there is an overdue task, the project service module 202 may generate and send a notification to the corresponding part(ies) to remind them about the overdue task.

In some embodiments, the architecture 200 may further include a task service module 203 configured for task creation and management, as illustrated in FIG. 2. Task 232 is a type of assignment that represents a one-off need for time to get some professional or personal work done, such as “write a proposal” or “mow the lawn.” A task 232 may map to assignment capacity in a mostly 1:1 way, with a few notable callouts, e.g., time policy, minimum duration and maximum duration, defend after, defended privacy, etc. Time policy 291, including working hours 293 and personal hours 294, may be determined based on the type of task. For example, a work event is created for working hours 293 and a personal event is created for personal hours 294. Here, the time policy 291 may be a global time policy 292 (e.g., 9:00 am-5:00 pm for working hours and the remaining for personal hours). Minimum duration and maximum duration are used to define the duration specified for the task, which can be set to be the same value (for a fixed duration) or different values (for a flexible duration). “Defend after” may define the due date for the task, which may be a user-defined value to indicate the due date for the task. Defended privacy means a task is never available to the public. The exact task setting for privacy may be defined by a user, which can be also public or private.

A task created based on the above-described callouts may have the following user-facing properties, among which, some (e.g., title and due date) may be optional. The user-facing properties may include title, type, time policy override, duration, due date, and minimum and maximum event durations. The event title may define the name of an event, which may map to the title of assignment 253 and appear in the corresponding assignment event 254. The event type may define a work or personal type of event, which may map to the respective global time policies for the work or personal type of event. In some embodiments, the default setting for the event type may be set to the work type or may be set according to the user's preference. The time policy override of an event may allow for “focus time” instead of the global time policy to be applied to an event, where the focus time may define certain special time durations, such as Monday/Wednesday/Friday, 6:00 am-10:00 am. The event duration may define the time required to complete the work, which maps to the minimum duration (e.g., 1 hour) and maximum duration (e.g., 2 hours). In some embodiments, the event duration may be set to a default value of 1 hour, although other default values are possible, based on the user preference. The event due date maps the “defend after,” which is a user-defined value. If the event due date is not supplied, it may mean there is no specific due date for the event.

In some embodiments, for each of the above user-facing properties, the architecture 220 may include default task settings 231 configured by the task service module 203, to facilitate task or event creation. By use of default task settings 231 to begin with task or event creation, it can save time in the management of the user events or tasks. For example, the intelligent calendar system 100 may use the default task settings 231 to create a series of tasks 232 and user events 216 that spread across the beginning to the end of a project 221. These events 216 and tasks 232 may be created in the form of a task list as well as the calendars or schedules that specify the timeline for the included user events or tasks. For example, these events may be placed into one or more calendars of individuals responsible for project 221.

In some embodiments, the default task settings 231 for an event or task creation may include settings for event type, event duration, event privacy, etc. The event type may define whether an event is a personal event or a work event. The default task settings 231 may set the default event type to be a static personal event or work event or may dynamically set the event type based on the context when an event is created. For example, if an event is created in a normal business hour and/or from a business-owned computer, the default task setting for the event type may be set as a work event. Otherwise, the default task setting for an event type may be set as a personal event. An event duration may define a duration of a normal one-off task. The default setting for event duration may be also static (e.g., 1 hour) or may be dynamically configured depending on the event type and user profile, among other possible factors. For example, if an event is identified as a personal event, the default duration may be set to 60 minutes, while the default setting for a work event may be set to just 30 minutes if the user's schedule is overbooked. In some embodiments, the default setting for an event duration may be determined based on the user profile (e.g., previous user activities). For example, if events for a user are found to be mostly 60 minutes for work-type events, the default setting for a work-type event for that user may be set to 60 minutes.

FIG. 3B illustrates example default task settings for creating an event or task. In the illustrated example, a user interface for adding a habit to a user's calendar is displayed. As can be seen, the default settings for the event type are set as a personal event, the time window is set to 8:00 am as the start time, 10:00 am as the ideal time, and 6:00 pm as the end time, and the duration is set to 1-hour minimum and 2-hour maximum. The default settings are provided for exemplary purposes and the default settings may be set to different values than those shown in FIG. 3B.

In some embodiments, the task service module 203 may further determine whether a task is prioritizable (block 251), or whether a task can be “boosted” in priority for a given week or day or alternatively can be deferred/excluded from being scheduled for a given week or day. This then allows the intelligent calendar system 100 to determine whether the task should be placed on this week's or next week's schedule.

In some embodiments, the task service module 203 may also determine the priority of a task (or a habit) based on the type and/or classification of a task (or habit). For example, a work task may have a higher priority than a personal task. For another example, the tasks classified based on a common color scheme may have different priorities. The events classified into blue-color type events (e.g., for solo works) may have a lower priority than the events classified into the green-color type events (e.g., 1:1 meetings), according to one example. In some embodiments, the task service module 203 may work with an AI-assisted prioritization module 209 included in the architecture 200. For example, AI-assisted prioritization module 209 may determine whether a project, task, or event is prioritizable, and if it is prioritizable, AI-assisted prioritization module 209 may even automatically assign a priority level for the project, task, or event, as will be described in detail later.

In some embodiments, task service module 203 may be configured to automatically block time in the intelligent calendar 211 for a created task 232 or event 216. For instance, task service module 203 may check the intelligent calendar of the user, then determine a proper time slot for the event or task based on the ideal time and maximum and minimum durations, among other factors. In some embodiments, task service module 203 may be configured to further determine the time slot for an event or task based on the priority of the event or task. For example, an event or task having a higher priority may be assigned to the ideal time slot while a low-priority task is assigned to the best available time slot after that.

In some embodiments, certain events created through the intelligent calendar system 100 may be considered as habits 241, as they occur multiple times per week, per month, or year. For example, the user event “take a walk” may occur multiple times a week, and the user event “email catch up” may occur early every morning on a weekday. In some embodiments, due to the repetitiveness of these habits, they can be automatically created by the intelligent calendar system 100, for example, by a habit service module 204 included in the architecture 200. To create the habits, the intelligent calendar system 100 may regularly wake up and create new or update existing assignments for the habits. In one example, for daily habits, the intelligent calendar system 100 may create new assignments every night outside the edge of a scheduler 205 that schedules the events or tasks. For weekly habits, the intelligent calendar system 100 may create new assignments every Sunday night outside the edge of the scheduler 205. For more complex frequencies, such as x times per week, the intelligent calendar system 100 may use a fairly complex assignment scheduling logic 242 for assignment creation. The fairly complex assignment scheduling logic 242 may use “Not Until” or “Never After” or other similar logics to determine how to schedule “x time per week” events. In some embodiments, the fairly complex assignment scheduling logic 242 may include a machine learning algorithm that determines to schedule events with complex frequencies by learning from the previous scheduling patterns for similar events from the same user or a large number of calendars of different users.

In some embodiments, habits 241 created by the intelligent calendar system 100 may also include user-facing properties, such as habit title, type, color override, time policy, frequency, defended privacy, minimum/maximum duration, notification, auto decline policy, CC others, keywords, among other features. The title for a habit 241 may be the name for the habit, which can be also used for the corresponding assignment and assignment events created from the habit. The habit type can be work, personal, or travel according to some embodiments. The habit color override may allow overriding a default color defined for the habit. The time policy may use either a global time policy or a focus time policy. In some embodiments, the time policy may also determine days and times (e.g., every night, every Sunday night) to schedule a habit. The habit frequency may define the repetitiveness pattern of a habit (e.g., daily, 3 times per week, every month, etc.). The privacy of a habit may define whether the habit should be private or public. The defended privacy may indicate that a habit never goes public. The maximum and minimum durations may be used to specifically define the duration of a habit, similar to the defining of a task or event. Notification for a habit may be enabled or disabled depending on the frequency of the habit. For a high-frequency event (e.g., a daily event), no notification may be necessary, while for a low-frequency habit (e.g., a monthly event), a notification may be necessary. Defense aggression for a habit may define the level of defense against another event or task. The defense aggression may be set to low, medium, or high depending on the priority level of the habit. Auto decline policy may define how to decline a habit during the scheduling process. The auto decline policy may be also determined based on the priority level of a habit. For example, a low-priority habit may be auto-declined if conflicting with a high-priority habit. CC others may allow the attendees of a habit to be copied. Keywords (e.g., lunch, exercise) may define a situation when a habit should be canceled or not to be scheduled. For example, if an event is seen with these keywords during a specified time policy and frequency, the assignment event should not be created or an existing one should be canceled.

In some embodiments, similar to tasks, habit properties also map to various parts of the system, which includes habit scheduling and post-processing. The habit scheduling may include a decision on which assignments associated with habits are to be put into or pulled out of the intelligent calendar 211. The post-processing may include further modification of certain habit properties for the resulting assignment events, which include but are not limited to color, privacy, defended privacy, notification, and CC others. For example, a forward-looking defense logic 260 may be applied to determine whether or not an assignment event is marked as free or busy based on the end user's availability. In some embodiments, the habit scheduling and post-processing may be implemented by the scheduler 205 included in the architecture 200, as further described in detail below.

The scheduler 205 may be configured to generate one or more assignments and resulting assignment events for an event or habit and use the generated assignment events to plan out a schedule. An assignment is a demand on a user's time assigned by the intelligent calendar system 100 to find space for a one-off task 232 or a recurring habit 241 within the user's intelligent calendar 211, while an assignment event is an event created by the intelligent calendar system 100 in service to an assignment. The assignments are generated by the scheduler 205 and thus a user does not work with assignments directly. An assignment may have, but is not limited to, the following properties:
Title—provided by the task or habit creator (via Task or Habit creation UI), to allow identification of the assignment in the UI and other systems (e.g., Google Calendar, Todoist, etc.).
Time Policy—the default range of time that the intelligent calendar system uses to schedule one or more assignment events to support the goal of finishing the assignment. This can link back to either a global time policy (e.g., working hours and personal hours) or a habit's time policy (e.g., daily, x times per week, etc.).
Time Policy Exceptions—a collection of intervals of time (date+time) that should also be considered to add to or exclude from the time policy.
Not Until—the date and time that the intelligent calendar system should use as a starting point to consider when scheduling.
Minimum Duration—the minimum amount of time, spread across all past and future assignment events, that is required to spend on the assignment.
Maximum Duration—the maximum amount of time, spread across all past and future assignment events, that is required to spend on the Assignment.
Minimum Event Duration—the intelligent calendar system will not schedule assignment events shorter than this.
Maximum Event Duration—the intelligent calendar system will not schedule assignment events longer than this.
Max Duration Cool Down—when an assignment event hits a maximum event duration limit, the amount of time that should pass before scheduling another assignment event.
Defend After—if any assignment event ends after this date and time, the intelligent calendar system will automatically defend all assignment events.
Defend Before—the number of minutes (e.g., 30 min, 60 min, 1440 min, etc) that the intelligent calendar system uses to look ahead and automatically defend assignment events, regardless of any other logic.
Auto Decline Policy—whether the intelligent calendar system should automatically decline any incoming meeting requests that overlap with defended assignment events.

As illustrated in FIG. 2, task 232 may generate one assignment 253, resulting in one or more assignment events 254, and a habit 241 may generate multiple recurring assignments 253, resulting in multiple assignment events 254. Once generated, the assignment events may be used by the scheduler 205 to plan out the intelligent calendar 211 (e.g., by the scheduler 205).

In some embodiments, the scheduler 205 may implement two different phases in the process of planning out a schedule, that is, a blocking phase 255 and a simulation phase 256. The blocking process is a phase that selects a time slot for each assignment event and the simulation phase is a phase that simulates an intelligent calendar for each involved member. During the blocking phase, the scheduler 205 may intelligently and automatically block time for each assignment event based on the default task settings, priority, event type, and overall schedule, among other factors. The scheduler 205 will try to place each assignment event into the corresponding ideal time, and make the necessary adjustment to find the next best time for an event if the ideal time does not work. Through intelligent planning, each assignment event may be placed into the intelligent calendar to plan out the user's schedule. It is to be noted that in real applications, not all events in a user's calendar come at the same time, and thus the intelligent scheduling of each assignment event is feasible for the scheduler 205.

In some embodiments, certain rules may be also predefined and used by the scheduler 205 in blocking time for each assignment event. Example rules may include, but are not limited to, events with higher priorities may be placed into prime time (e.g., morning hours between 9:30-11:30 am) during the time blocking process, fewer events are scheduled for Fridays, face-to-face meetings are not scheduled on days close to holidays, and so on. In some embodiments, a user may define a personalized rule based on his/her personal preference or certain other considerations. For example, a user may frequently work late and thus prefer to attend meetings in the afternoons, and thus the user may define a rule to avoid meetings scheduled in the mornings for the user. In some embodiments, there may be other types of rules that can be predefined by the disclosed system, as can be seen in different embodiments throughout the specification. In some embodiments, certain predefined rules may be further dynamically updated. For example, in view of a policy change for an organization (e.g., remote workers need to report to the office on Wednesdays), the scheduler 205 may automatically update one or more predefined rules in scheduling (e.g., by scheduling more meetings on Wednesdays in view of the aforementioned policy change).

During the simulation phase, each selected time slot is checked to ensure that there is no conflict between the selected time slots. In addition, if there are multiple attendees, the simulation phase may simulate an intelligent calendar for each attendee to make sure that there is no conflict within each calendar or between different calendars.

In some embodiments, the scheduler 205 may add certain buffer events during the blocking phase. In normal life, back-to-back meetings or other similar events may take a serious toll on a user's productivity and overall health. The buffer events may be placed before and/or after an assignment event to supply the necessary buffer, to ensure that the user has the necessary time to prepare before or rest after certain assignment events. For example, anytime the intelligent calendar system 100 sees a meeting that contains a videoconference link, the system 100 may automatically add a chunk of time afterward to make sure the attendees get some time to decompress. The exact time length of the chunk of time for a buffer event may be set to a default value (e.g., 15 min) or may be manually defined by a user, and the display of a buffer event may be set to be “decompression time” or “busy” according to the default setting or according to user preference.

In some embodiments, the buffer events may include but are not limited to, pre-travel buffer events, post-travel buffer events, and conference buffer events. These buffer events are considered as logistics-type events. The scheduler 205 generally handles the pre-travel and post-travel buffer events before any other scheduling as these events are immovable. On the other hand, the conference buffer events are considered as “best-effort” events in the scheduling priority if a room is available. If a room is not available, these buffer events may be not necessarily added to a conference event. The exact timing regarding how a conference buffer event is scheduled may vary and depend on many different factors, such as room availability, number of attendees, length of the conference, the importance of the conference, etc.

In some embodiments, the scheduler 205 may be also configured to determine a time horizon during the blocking phase of the scheduling process. That is, the scheduler 205 may determine which periods of time should be used to plan out the agenda for the associated users. According to one embodiment, the scheduler 205 may use three kye time horizons during the blocking phase of the scheduling process, which include day, week, and ideal types of time horizons. The day horizon, or day plan 252, may be chosen by the scheduler 205 when a user only wants to get through a day (e.g., today or a specific day in the near future). This is normally used when such a day is very important or special or a related assignment event has a very high priority. For example, the scheduler 205 may use a day plan for a day that requires a dental appointment, which may last hours due to the complex procedures expected for the appointment. If nothing special, the week horizon, or a week plan 252, may be chosen instead by the scheduler 205. The week horizon or week plan is chosen as a default time horizon, as a week plan is most commonly used by users and it aligns with weekly planning rituals. In some embodiments, there is a special time horizon, which is also called the ideal horizon or ideal plan 295 when a user is unencumbered from specific meetings and obligations and thus needs to think carefully about how to spend the time in such a situation. In some embodiments, by using the ideal horizon, the scheduler 205 may generate an ideal plan that includes a stack-ranked list of individual habits plus an indicator/proxy for where all tasks should be scheduled. The exact order of these habits and tasks included in the ideal plan 295 may be changed at certain time points, and the change may impact future day plans and week plans 252.

In some embodiments, each of day plan, week plan, or ideal plan may have an associated time policy. As described earlier, a time policy includes days and time ranges that pertain to a user's life and goals. The most common time policy is working hours (e.g., Monday-Friday 9:00 am-5:00 pm), but it can also be something more narrowly defined, such as “focus time” (e.g., Monday, Wednesday, and Friday 6:00 am-10:00 am) as described earlier. In some embodiments, the time policy can also become sophisticated. For example, the time policy for a week can be like this:
Monday—Thursday: 6:00 am to 9:00 am, 10:00 am to 5:00 μm, 8:00 μm to 10:00 pm
Friday: 8:00 am to 4:00 pm
Sunday: 10:00 am to 12:00 pm

In the scheduling process, the time policy described above is a key input to assignments or more specifically assignment events, as it provides the acceptable range for which the assignment events can be scheduled. That is, a day, week, or ideal plan is built within the acceptable range defined by the time policy, and the assignment events are only scheduled within the acceptable range in each of the day, week, or ideal plan. As previously described, scheduler 205 may use two types of time policies during the scheduling process. The first type of time policy is the general time policy that includes working hours 293 and personal hours 294, and the second type of time policy is a time policy that is linked to individual user habits (e.g., x times a week), as previously described.

In some embodiments, besides the time policy, the scheduler 205 may also consider whether a task or habit is prioritizable during the blocking phase of the scheduling process. That is, during the scheduling process, an individual task or habit can be boosted in priority for a given day or week or can be deferred or excluded from being scheduled for a given day or week. To schedule prioritizable tasks or habits, scheduler 205 may define certain prioritization windows or deferred windows. The prioritization windows include days or weeks that a schedule should give higher priority during the scheduling process, while the deferred windows include days or weeks that the scheduler 205 will not schedule any events or tasks. Here the following are example processes for generating an ideal plan by the scheduler after considering the time policy and prioritizable tasks or habits, according to some embodiments.

Suppose that a week plan looks like the following:
Morning catch up
Lunch
Work tasks
Afternoon catch up
Exercise
Personal tasks

And also assume that there are two tasks on the to-do list:
Work task: circle back with investor X
Personal task: schedule a doctor's appointment

The week plan would initially expand out to the following:
Morning catch up
Lunch
Circle back with investor X
Afternoon catch up
Exercise
Schedule doctor appointment

At this point, suppose that a user feels especially behind health-related concerns and has decided to prioritize the doctor appointment as well as the exercise habit. In addition, the user realizes that investor X can be deferred for a month. So after some tweaks, the ideal plan may look like the following:
Exercise
Schedule doctor appointment
Morning catch up
Lunch
Circle back with investor X
Afternoon catch up

In other words, the prioritized habit and task are considered in a separate, higher priority ideal plan with boosted ranking when compared to other habits or tasks, but still maintain their relative orders. The remaining items or objects in the expanded ideal plan are considered below those prioritized habits and tasks, in the same order as before.

It is to be noted that while the above has been described with reference to a week plan, the same process may be applied to a day plan, except more narrowly scoped to a single day in a given week. In addition, while the above prioritizable habit and task get a higher priority based on the user input, in some embodiments, a habit or task may be boosted in the priority based on the event type, user profile, and certain other factors. For instance, certain keywords (e.g., boss) may be identified by using the semantic logic and the related events are given a higher priority based on the previous arrangement of the similar keywords-related events or tasks. In some embodiments, a machine learning-based mechanism may be employed to identify the priority and further rank certain tasks or habits. For example, the machine learning-based mechanism may find such keywords-related events or tasks are put into the top priority in most other calendars, and thus these events are also ranked higher in the ideal plan or in the day or week plan.

In some embodiments, after the day, week, and ideal plans are determined, the scheduler 205 may block time slots and plan out a schedule for each individual. The scheduler 205 may schedule the tasks and habits according to the order of the items or objects in the day, week, and ideal plans. That is, an item or object with a higher rank in a plan is scheduled first, and a lower-ranked item or object is scheduled next. In this way, the assignment events 254 associated with these tasks and habits can be then placed into the calendar to plan out the schedule for an associated individual.

In some embodiments, the planned assignment events may be further colored by the decoration service module 206 of the architecture 200, to provide color for each event included in the calendar, as further described in detail below. According to one embodiment, a forward-looking defense logic 260 may be applied to determine whether to apply color to each assignment event.

In some embodiments, besides planning out the schedule or calendar, the scheduler 205 may be also configured to handle the incoming new events 216 that occur during event integration or through other means (e.g., RSVP or please respond). If these user events 216 overlap with assignment events already planned out in the calendar, the scheduler 205 may auto-decline these user events 216 by default, as indicated by block 257. In some embodiments, the scheduler 205 may also determine the priority of an incoming user event, and determine whether to automatically move some already scheduled tasks or habits to accommodate an incoming user event if the priority of the event is high.

In some embodiments, if a user event is declined, the user event may be forwarded to the calendar persistent service module 207 of the architecture 200, to indicate the event overlap and the decline by the scheduler 205. In some embodiments, if a user event 216 is placed into the calendar, the user event may be then processed by the decoration service module 206 of the architecture 200 to decorate the color for the user event 216, as described below.

The decoration service module 206 may be configured to automatically categorize the events or habits in a calendar. In other existing color-based categorizations in a calendar (e.g., Google Calendar), a user may be required to manually select an event to colorize an event. In the intelligent calendar system 100, the decoration service module 206 may be configured to automatically color-code the events based on the intelligently detected categories. For example, the team meetings may be automatically identified and colored orange, solo works may be automatically identified and colored blue, personal tasks may be automatically identified and colored pink, travel and logistics events may be automatically identified and colored red, and external meetings may be automatically identified and colored to green, and one-to-one meetings may be automatically identified and colored to purple, and so on. It should be noted that the color scheme described here is for illustrative purposes and not for limitation.

In some embodiments, to intelligently detect event categories, the decoration service module 206 may employ a machine learning engine included in the intelligent calendar system 100 that is configured to automatically identify the assignment event categories. For example, the machine learning engine may include a semantic logic to identify the keywords based on the user inputs, determine whether a meeting is internal or external based on the email communications (e.g., domains associated with emails), and whether a meeting is a one-to-one meeting based also on the email communications (e.g., how many invitation emails are sent through email), whether an event is a travel event based on the order detail detected from email, etc. The decoration service module 206 may then automatically color code or apply color to each categorized event. In some embodiments, the decoration service module 206 may apply color to only events generated through the intelligent calendar system 100 (such as tasks 134, habits 241, and certain synchronized calendar events 283 as will be described later). In some embodiments, the decoration service module 206 may apply color to all events that occur in a calendar, that is, the user events that occur in the calendar are also colored, as indicated in the operation 259.

In some embodiments, by coloring events included in a calendar, a user can easily see where his/her time is going with a simple glance. For example, the user does not need to click each user event in the calendar user interface to determine where the user's time is going. This then saves time and computing resources since the user does not need to touch anything in the calendar user interface. This is especially important for a power-stringent mobile device with a small screen. For such as device, a user may need to click each event and further zoom in to see the detailed information of each event, due to the small screen size of the device which may prevent detailed information from being displayed in the calendar user interface. By coloring events in the intelligent calendar, the user then does not need to click and/or further zoom in to see where the user's time is going, since the color of each event can be easily visible even when the screen size of the device is quite small.

As described earlier, the architecture 200 may further include a sync service module 208 configured to implement the calendar synchronization, or more specifically, event synchronization between different calendars, e.g., between the intelligent calendar and the Google Calendar or between a user's personal calendar and work calendar. To implement the synchronization process, the sync service module 208 may first set the source calendar to have “view all details” level permission. In some embodiments, free/busy kind of information may be not enough due to the challenges with recurring events. Meanwhile, the sync service module 208 may set the target calendar to have “event write” level permission. In some embodiments, the “view all details” and “event write” level permissions may be obtained when a user registers into the intelligent calendar system 100 or when the user installs the related applications. In implementations, the intelligent calendar generated by the intelligent calendar system 100 can be either a source calendar 213 or a target calendar 281, as described earlier.

In some embodiments, the sync service module 208 may employ certain sync policy 282 during the synchronization process, where the sync policy may define how the sync service module 208 should monitor a source sync calendar and create new events on a target sync calendar. The sync policy may use the following properties in the process of creating new events on the target sync calendar: type, color override, privacy, and sync outside working hours. The event type may define whether a created new event is a personal, work, or travel event. The event color override may define whether to override the color inherited from the source sync calendar. According to one embodiment, the sync service module 208 may use the default color settings in the target sync calendar to determine whether to override the color of a new event created through the calendar synchronization. In some embodiments, user preferences may be used instead, which means that a user can manually override the color of a synchronized (“synced”) new event, or the color can be overridden based on the user preference stored in the intelligent calendar system, e.g., stored locally or in the cloud in the user profile associated with the user.

An event created through the calendar synchronization may be specifically referred to as sync event 283. In some embodiments, a sync event 283 may be placed on the target sync calendar as other assignment events created for the tasks or habits. In some embodiments, a sync event 283 may include additional information indicating the source sync calendar from which the event was synchronized. For instance, a sync event 283 displayed in the calendar UI may itself be a link directing to the source sync calendar. Once clicked, the source sync calendar may be triggered to open, to allow a user to see more detail about the sync event 283.

In some embodiments, to facilitate calendar synchronization between different calendars associated with the user and to facilitate the integration of the disclosed intelligent calendar application into other calendars or event organization platforms, the architecture 200 may additionally include a calendar persistent service module 207 configured for calendar integration. Such calendars or event organization platforms configured for integration may include, but are not limited to, Google Calendar (“271” in FIG. 2), Slack, Zoom, Google Tasks, Todoist, Asana, Jira, ClickUp, monday.com, Trello, Office 365 (“272” in FIG. 2), etc. By integration into different platforms, it can allow a user to manage the user events across different platforms.

For example, by integrating into Slack, a user may create tasks, reschedule events, update status and stay on top of the agenda, all of which can be done through Slack. The user does not need to come back to the intelligent calendar system to manually input these tasks, rescheduled events, updated status, etc. Instead, the tasks, rescheduled events, and status updates can be automatically performed in the intelligent calendar system 100 when the user uses Slack.

By integrating into Zoom, a user status can be automatically updated when the user enters and leaves a Zoom call, which may make the Zoom call less distracted due to automatic status updates displayed to others.

By integrating into Google Calendar and Google Tasks, tasks that appeared in Google Tasks may be automatically scheduled with smart time blocking in Google Calendar before the due dates of these tasks. For example, the integrated intelligent calendar application may automatically find the best openings in Google Calendar using smart time blocking and keep that time available for adjustments until a user starts to run out of options or is close to the due date. In addition, the integrated intelligent calendar application may automatically block time for important tasks as soon as these tasks come up right through the user's email inbox, and automatically schedule these tasks in the Google Calendar when the intelligent calendar application is integrated into the Google Tasks.

By integrating into Todoist, the intelligent calendar application may auto-schedule time to work on a user's to-dos so that the user can stay organized and better plan his/her work. For example, the integrated intelligent calendar application can automatically find and defend the best time to work on the project tasks that appeared in the Todoist. The intelligent calendar application's smart time blocking keeps the user's time aligned with the user's projects and priorities while keeping the user flexible for new events. In addition, by controlling how much time a user schedules for each task through simple time estimates or scheduling an hour for each task by default, a user can easily add, reduce, or break up time blocks through the integrated intelligent calendar application. In some embodiments, the integrated intelligent calendar application may automatically assign tasks to team members and automatically block time on their calendars so that the user can have fewer meetings and better communication around priorities.

As described above, in some embodiments, a specialized AI-assisted prioritization module 209 may be further figured in the disclosed intelligent calendar system 100, to determine a priority of each event, habit, or task, which then allows the system (e.g., scheduler 205 or other components included therein) to organize events, tasks, or projects in calendars according to the determined priority of each event, habit, or task. In some embodiments, the specifically configured AI-assisted prioritization module 209 may be configured to allow cognitive scheduling of a single calendar by multiple entities or cognitive scheduling of multiple calendars by a single entity, where the multiple calendars may be across different platforms (e.g., zoom scheduling or outlook calendar platforms). Towards this objective, an AI-based mechanism may be employed to make cognitive associations between the data sources by creating a uniform data format that can be uniformly accepted by different scheduling platforms, where the uniform data format may allow each scheduling platform to easily identify the priority of each event when scheduling the to-be-scheduled events.

According to one embodiment, the AI-assisted prioritization module 209 may be configured to define or identify the priority of each event (or task, project, 1:1 meeting, and so on) by leveraging metadata associated with each event. For example, the prioritization module 209 may leverage the metadata associated with an event to define or identify whether a to-be-scheduled event is under the control of an AI-assisted scheduling application (e.g., the intelligent scheduling system 100). The prioritization module 209 may also leverage the metadata to further define or identify the priority level of an event if the event is under the control of an AI assistant. The following Table-1 provides some exemplary event-related properties that may be defined through metadata associated with an event.

TABLE 1
Properties of Events Defined through Metadata

| Property | Example Values | Description |
|---|---|---|
| ai.controlled | true/false | Is the event under the control |
| | | of an AI assistant? |
| ai.vendor | reclaim, zoom | Which vendor is controlling |
| | | this event? |
| ai.locked | true/false | Is the event locked in place or |
| | | might it move? |
| ai.priority.level | 1, 2, 3, 4 | User-facing prioritization levels |
| ai.priority.sublevel | 1-100 | Internal, system-generated |
| | | fine-tuned priorities |

As can be seen from Table-1, metadata may be used to define whether an event is under the control of an AI-assisted scheduling application (or simply AI assistant), and which vendor (e.g., the disclosed intelligent calendar system or another automated or semi-automated third-party application or scheduler such as Zoom) is controlling this event if it is under the control of the an AI assistant. The metadata may be also utilized to define whether an event is locked in place or it may be movable to another place, or utilized to define other information related to scheduling for a to-be-scheduled event.

In some embodiments, these features or scheduling related information defined through metadata may increase the flexibility in scheduling. For example, through the first three features defined through metadata as shown in Table-1, an event may be determined to be potentially available to reschedule should a conflicting event overlap with it. Without these properties defined through metadata, AI assistant (e.g., the intelligent scheduling system 100) may simply assume that an event is not controlled by any other software or application, and thus is fixed in place until a user changes it. The normal free/busy signals are then relied on when considering availability in scheduling other events.

Accordingly, if metadata is leveraged to define the priority-related information of an event, the metadata associated with the event may be first checked when scheduling. For example, when scheduling an event, the AI assistant (e.g., the disclosed intelligent calendar system 100) may first check the metadata associated with an event. As a specific example, if it is found that the ai.controlled property is set to true in the metadata associated with an event, it indicates that the event is under the control of an external scheduling service declared in the ai.vendor property. This means that the event may be able to move should a conflict arise. However, if the ai.locked property is found to be true based on the event metadata, the event should be then assumed as busy and will not be able to move, even if a conflict occurs.

In some embodiments, if an event is determined to be controlled by an AI assistant and not locked in place based on the metadata information, the next step may include determining the priority of the event. This can be also achieved by leveraging the metadata defined for an event, as can be seen in the ai.priority.level and ai.priority.sublevel in Table-1. By defining the priority levels of the events already on the calendar and the to-be-scheduled event(s), the AI assistant (e.g., the disclosed intelligent calendar system 100) may then decide which events already in the calendar should be treated as busy and which events can be offered up as free time (e.g., allowing the disclosed intelligent system or other AI assistants to move the event) when a conflict arises in scheduling.

In some embodiments, different approaches may be employed to define the priority levels of events through metadata. In one example, as shown in Table-1, the priority levels of events may be defined by including user-facing prioritization levels and internal/system-generated prioritization sublevels. The user-facing prioritization levels may be coarse-grained priority levels, while the internal/system-generated prioritization sublevels may be fine-tuned priority sublevels that can be used to further define events sharing a same coarse-grained priority level, as further described in detail below.

According to one embodiment, four course-grained priority levels may be employed to define, e.g., to classify events to be scheduled, as shown below:
P1—Urgent
P2—High
P3—Normal
P4—Low
   Here, an event having an urgent priority may have a higher priority level than an event having a high priority, an event with a high priority may have a higher priority than an event having a normal priority, and an event having a normal priority may have a higher priority than an event having a low priority. Accordingly, during a scheduling process, a P1 scheduling request (a request for an event having an urgent priority) may offer up busy times for unlocked P2, P3, and P4 events, but not P1 events nor locked events of any priority, a P2 scheduling request may offer up busy times for unlocked P3 and P4 events, but not P1 or P2 events nor locked events of any priority, and a P3 scheduling request may offer up busy times for unlocked P4 events, but not P1, P2, or P3 events nor locked events of any priority.

It should be noted that the above classification is merely for exemplary purposes. In some embodiments, three, five, or another number of coarse-grained priority levels may be employed instead, which are not limited in the present disclosure. In some embodiments, the definition or classification of the course-grained priority levels, once determined, may be shared across different platforms, so that the priority definition and classification may be universally understood by customers who may access different scheduling platforms.

In some embodiments, as shown in Table-1, course-grained priority levels may be reflected in the ai.priority.level property of the metadata by using numerical values, such as integers of 1, 2, 3, 4, and so on, where a smaller number may mean a higher priority. For example, an event with an urgent priority may have a value of 1 defined through the metadata.

In some embodiments, to allow for further refinement, an internal sublevel of priority for an event may be further determined by an AI-assisted (e.g., the intelligent calendar system 100). Once determined by the AI assistant, such sublevel priority information may be also included in the metadata associated with the event. The above Table-1 shows an exemplary sublevel priority feature expressed as ai.priority. sublevel.

In some embodiments, the sublevels of priority may be also defined through numerical values, such as 1, 2, 3, 4, 5, 10, 20, 30, 40, 50, 60, 70, 80, 90, 100, and so on. In some embodiments, there may be a large number of sublevels of priority when compared to the coarse-grained priority levels. For example, there may be a number of priority levels ranging between 3-10 (or another range), and there may be a number of sublevels ranging between 10-100 (or another range) for each priority level. In some embodiments, the number of fine-tuned sublevels for each coarse-grained priority level may be different. In one example, there may be 50 sublevels for a priority level “urgent,” while there may be 100 sublevels for a priority level “normal.” In some embodiments, there may be a same number of sublevels for each priority level. For example, in one embodiment, each priority level may have 100 sublevels of priority. In some embodiments, instead of using a large number of sublevels, there may be even sub-sublevels included in the disclosed system. That is, a sublevel of priority may be further defined to have multiple sub-sublevels.

In some embodiments, by defining the sublevels (and/or sub-sublevels) for the coarse-grained priority levels, it allows to break ties between events of the same priority level. For example, a service that provides a P1 priority scheduling link may offer up all P2/3/4 events, but not P1 events. By including sublevels of priority, even certain events at a same level of coarse-grained priority may offer up for scheduling. For example, a P1 event with a lower sublevel priority may offer up as free for scheduling a P1 event with a higher sublevel priority.

In some embodiments, similar to coarse-grained priority levels, a smaller value may indicate a higher priority for sublevels. For example, 1 may be the highest sublevel (most important) while 100 is the lowest (least important).

In some embodiments, the values for coarse-grained priority levels may be user-facing, which means that a user may define a coarse-grained priority level for an event, which can be further saved in the metadata when the event is created by the user. In some embodiments, the sublevels may be not user-facing, but rather are defined by an AI assistant (e.g., the intelligent calendar system 100). For example, the intelligent calendar application disclosed herein may automatically determine fine-tuned scheduling and prioritization within each of the coarse-grained priority levels. In some embodiments, even the user-facing coarse-grained priority levels may be also determined by the AI assistant, for example, to expedite a scheduling process if no priority information is provided by a user when the event is created for scheduling.

In some embodiments, if no priority sublevel is determined for an event, it may be assumed to be 1 by default by an AI assistant when scheduling the event. Alternatively, an event may be chosen to default to another value. For example, the AI assistant (e.g., the intelligent calendar system 100) may choose to default a sublevel value to 50 for a dynamic recurring 1:1 series.

In some embodiments, an AI assistant (e.g., the intelligent calendar system 100) may be equipped with one or more machine learning models for determining the exact values of sublevels of priority for the events. A machine learning model may be trained to predict the priority of events by looking into many factors that affect the priority of events (the machine learning model thus may be also referred to as a priority predictive model). For example, the priority predictive model may be trained by inputting a lot of calendars from different users, to understand which types of events are more important than other types. The events in the calendars may have defined priorities that allow to identify a scheduling pattern for scheduling events with different priorities. For example, events with higher priorities may be scheduled to primer time. Alternatively, the priority predictive model may look at scheduling patterns to determine priorities for events in these calendars (e.g., events scheduled to primer time may have higher priorities). In some embodiments, the priority predictive model may be trained to extract the sematic meaning of words used for describing the events, and then determine the priority of events based on the semantic meaning of these words. For example, a meeting with a director may have a high priority if an event description includes a word “meeting” and a word “director.” In some embodiments, the priority predictive model may be trained to determine the priority based on the number of attendees for an event (e.g., a larger number of attendees may have a higher priority due to the scheduling difficulty). In some embodiments, the priority predictive model may be trained to determine the priority of events based on other factors not mentioned above, for example, based on the role of the person who submits the scheduling request (e.g., a person with a higher job level may have a higher priority), based on the preferred time slots (e.g., a large number of time slots may have a lower priority), based on the time that request is generated (e.g., a late night request may indicate a high priority), and many other possible factors. In some embodiments, the priority predictive model may be also trained to take into consideration personal profile in determining the priorities of events. For example, some users may take certain events more seriously than other events, while other users may take different events more seriously.

In some embodiments, the priority predictive model disclosed herein may be one of a regression model (e.g., linear regression, logistic regression, or polynomial regression), decision tree, random forest, support vector machine, Naïve Bayes model, k-means cluster, or neural network (e.g., feed-forward networks, convolutional neural networks (CNN), deep neural networks (DNN), autoencoder neural networks, generative adversarial networks, or recurrent networks (e.g., long short-term memory networks (LSTM), bi-directional recurrent networks, deep bi-directional recurrent networks), or any combination thereof. In one example, the priority predictive model may be a classifier that includes both a linear regression and a decision tree (e.g., for determining the coarse-grained priority levels).

In some embodiments, the priority predictive model may be trained using a machine learning implemented method, such as any one of a linear regression algorithm, logistic regression algorithm, decision tree algorithm, support vector machine classification, Naïve Bayes classification, K-Nearest Neighbor classification, random forest algorithm, deep learning algorithm, gradient boosting algorithm, and dimensionality reduction techniques such as manifold learning, principal component analysis, factor analysis, autoencoder regularization, and independent component analysis, or combinations thereof. In a specific embodiment, the priority predictive model may be trained using supervised learning algorithms, unsupervised learning algorithms, semi-supervised learning algorithms (e.g., partial supervision), weak supervision, transfer, multi-task learning, or any combination thereof.

In some embodiments, the use of a machine learning-based model can alleviate problems typically encountered by a computing system that may employ a conventional programming solution, such as running out of allotted processing capacity and/or time, running out of memory, excessive power consumption, etc. This is accomplished in part, by avoiding an exhaustive exploration of all the potentially feasible algorithms because the number of such algorithms can grow exponentially, and the application of all such algorithms to the calendar data of different users can become computationally prohibitive even for the largest and fastest known computing systems. Rather than performing such exhaustive exploration, the priority predictive model described herein learns priority levels better from past experience. Using learned priority levels, the priority predictive model can isolate the algorithms that are likely more relevant to determine priority levels, where such algorithms can be applied more efficiently, and without exceeding the available computing resources in terms of processing capacity (e.g., specified as million instructions per second (MIPS)), processing time, specified as actual time (in minutes, seconds, hours, etc.), and/or as CPU time (in microseconds, seconds, or minutes), and memory capacity.

In some embodiments, the priority predictive model, once trained for a specific individual, entity or organization, may allow to generate a priority score for each to-be-scheduled event by taking into consideration all of the possible impact factors. The generated priority score may be then used to determine the sublevel of priority for each to-be-scheduled event when a new request is received. In some embodiments, even a coarse-grained priority level may be also determined for an event by the trained priority predictive model. For example, the outer layer of the priority predictive model may automatically classify an event to one of the defined coarse-grained priority levels mentioned above.

In some embodiments, the sublevels of priority for events initially determined by the priority predictive model may be further dynamically updated by an AI assistant based on changing conditions. For example, a user may change a coarse-grained priority level of an event, and thus a sublevel may be changed consequentially. In one example, a user may change a P3 event having a normal priority to a P2 event having a high priority. Responsive to this change, an AI assistant may reevaluate the sublevel priority for the event, and adjust the sublevel priority of the event correspondingly, e.g., from 10 to 90 (i.e., from P3-10 level to P2-90 level).

In some embodiments, even if there is no change in the coarse-grained priority level for an event, a sublevel may be also dynamically adjusted. For example, an event may be one of a series of events for a project. In such a situation, a change of the priority level and/or sublevel of one event may cause a corresponding change of another event in the series, including a possible change of sublevel but not the coarse-grained priority level of that event. In another example, if a dynamic recurring 1:1 series is overdue (e.g., behind the schedule according to the recurrence rule), the AI assistant may raise a single instance's sublevel up (e.g., from 50 to 5), to ensure that it is more likely to happen (i.e., get scheduled as expected). In yet another example, an AI assistant may adjust the sublevel priority for an event when time passes by. For example, the AI assistant may choose a sublevel priority of an event to start with a value of 100 on the day of scheduling, and then gradually adjust the sublevel to 1 over the next 30 days, ensuring even more availability opens up further out into the future.

In some embodiments, in order to prevent too much change to a user's agenda, an AI assistant may suggest that the priority sublevel for an event is capable of being modified or updated at a predefined frequency, e.g., no more than once every 24 hours, every 48 hours, every 72 hours, etc.

In some embodiments, to facilitate the priority defined through metadata to be easily captured for scheduling, certain priority-related metadata information may be also encoded in an event ID itself. This has the benefit of allowing the priority-related information of events to be visible even for calendars that have access only to free/busy data and no other details. For example, the equivalent of ai.controlled in metadata can be determined by examining the event ID and base32-decoding it (e.g., using the characters 0-9 and a-u). One such example event ID before and after decoding is shown in FIG. 3C. It should be noted in the figure, the term “reclaim” in the decoded event ID refers to an application name, which means that the event is defined through an application called “Reclaim.” If an event is defined through another different application, a different name may be used instead.

In some embodiments, if the decoded value for an event starts with “reclaim-assist-custom-daily:” or “reclaim-assist-task:,” then it is assumed that the event is under the control of the “Reclaim” application (or another application if “reclaim” is replaced with another application), and potentially invites conflicts in scheduling. In some embodiments, other Reclaim-scheduled events may also exist, but these events may not be available for an AI-assisted scheduling process. For example, for events that are defined through the Reclaim application, an event's shared metadata may also have a reclaim.lockState property that matches roughly to the ai.locked property described earlier. In some embodiments, if shared.lockState contains one or more of the following values, it may be assumed that an associated event is locked and ineligible for conflict:
Manually_Locked
Adjusted
PComing_Window

In some embodiments, once the priority information for an event is determined, an AI assistant may automatically schedule events for a calendar based on the determined priority information for events. For example, the scheduler 205 may schedule the events according to the rank of the priority scores for the events. An event with a higher priority may be scheduled first with a preferred time slot, while an event with a lower priority may be scheduled later or even not scheduled right away.

In some embodiments, priority defined through metadata for an event may be used in other means. For example, priority information in metadata may be further utilized in creating scheduling links. One type of such a scheduling link is a custom URL allowing a person to share availability instantly with others. It eliminates the back-and-forth coordination of finding a meeting time. For example, by sending a scheduling link in a game of calendar Tetris, it eliminates Slack messages and lengthy email threads in scheduling, which greatly saves the bandwidth and computing resources required by the scheduling applications. In scheduling links used in existing scheduling applications, the events associated with the links generally do not have priority properties that can be readily recognized by scheduling applications.

In the disclosed intelligent calendar system 100, the scheduling links may be generated by embedding the priority information for the associated events. For example, the AI-assisted prioritization module 209 may generate a scheduling link that also incorporates the priority information obtained through metadata associated with the events in a calendar. The AI-assisted prioritization module 209 may look into the metadata associated with events included in the calendar when generating a scheduling link. The priority information for events may be then shared through the scheduling link, to allow another scheduler to schedule the events by also considering the priority of events included in the shared calendar. For example, by incorporating the priority information into a scheduling link, an AI assistant receiving the link may then determine whether to adjust the availability of the events in the calendar, e.g., by treating certain lower priority events as free, so that an event with a higher priority may have more available timeslots for scheduling.

In some embodiments, the AI-assisted prioritization module 209 disclosed herein may generate a specialized scheduling link called a high priority scheduling link. A high-priority scheduling link is a link generated for scheduling an event with a high priority with others. For example, a user may receive a high priority scheduling link from another user. The scheduling application for handling the scheduling link may maximize the availability of the to-be-scheduled event by treating habits, tasks, and smart 1:1s with lower priorities as free, even if those events are currently marked as busy.

In some embodiments, a high-priority scheduling link may incorporate the priority information obtained from metadata associated with the event when the link is generated. The priority information of the event reflected by the metadata may be determined as described above. For example, the priority information for an event may include both a coarse-grained priority level and a fine-tuned priority sublevel. An AI assistant for handling such scheduling link may directly look into the priority sublevel for the to-be-scheduled event, and may further maximize the availability of the event by treating events with lower sublevel priorities as free, even if these events are currently marked as busy.

In some embodiments, high-priority links may be also generated as team links or group links, where an event with a high priority may be scheduled between team members or within a group. For example, when a team high priority scheduling link is created for an event with a high priority, an AI assistant may automatically look across all teammates' calendars and treat their tasks, habits, smart 1:1s, and decompression time as free or available to schedule. This is especially useful when trying to book across a lot of busy people in a team. High-priority team links shorten the time and resources needed to negotiate which tradeoffs people need to make on their calendars. In some embodiments, a team high priority scheduling link may also look into sublevel priorities, and may also treat events with lower sublevel priorities as free even if these events have a same coarse grain priority level. This is useful especially when every team member is kind of busy with some important tasks or projects, such as year-end closing for a financial team when everyone is trying to beat the clock to close the book.

In some embodiments, the priority information defined through metadata associated with events may be utilized in other situations, such as for determining the colors of events in a calendar, as described earlier.

It is to be noted that the above-described features and advantages for the integration of the intelligent calendar application to different platforms are just for exemplary purposes. In real applications, additional features or advantages for the integration of intelligent calendar applications become apparent when integrating into other different calendars or event organization platforms. In addition, as illustrated in FIG. 2, when there is any change to the events and tasks associated with a user in the integrated platforms, it will also automatically trigger changes in the tasks and events associated with the user in the intelligent calendar system, without waiting for watch by the user in the intelligent calendar system 100, as indicated by the arrow 273 in FIG. 2. The triggered automatic changes in the intelligent calendar system may include a change to event 212 or synchronization of calendar 211, as described earlier.

It is also to be noted that the described organization of the architecture 200 provides just one implementation of the disclosed intelligent calendar system 100. In actual applications, the intelligent calendar system 100 may include more or fewer functional modules than those described above. In addition, the intelligent calendar system 100 may include additional features and advantages not disclosed above, which will become apparent in view of various applications, as described in the following exemplary embodiments.

### Exemplary Embodiments

### 1. Make Time for Habits

In other existing calendar or event organization platforms, time blocking has been widely used to schedule blocks of work on a user's calendar. It is a great way to give the space the user needs to focus on the stuff that matters to the user, and ensure that the user gets heads-down time in between many meetings the user has to attend every week.

But time blocking is pretty hard to accomplish in practice in other existing calendar or event organization platforms. A user might spend all evening Sunday night blocking out the perfect workweek, but none of that matters come Monday morning. The user may quickly find that meetings have collided with the user's time blocks, and thus the user has to spend a bunch of time again to get back on track.

The intelligent calendar application disclosed herein provides a much more adaptive way to block time. According to embodiments disclosed herein, a user does not have to worry about manually doing the work. Instead, the user can define routines that the user wants to spend time on each week and integrate the user's task list to make time for the user's to-dos before they're due, and the intelligent calendar application automatically finds time for the tasks in the user's busy schedule.

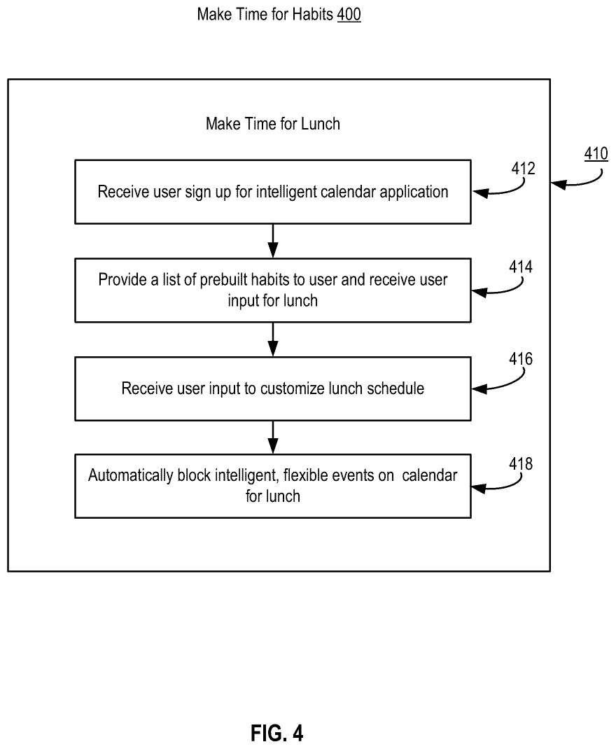

In addition, the user does not have to worry about doing the user's routines or tasks at the same time every week, or sticking to a super static plan. Instead, the intelligent calendar application uses user preference and/or input to find optimal time slots for the routines or tasks, and moves the routines or tasks around when interruptions occur to accommodate inbound meetings. A specific process for intelligent scheduling of a habit is further described with reference to FIG. 4.

FIG. 4 is a flow chart of an example method 400 for creating a habit, according to some embodiments. As illustrated, the method 400 for creating a habit is illustrated with reference to a specific process 410 of scheduling time for lunch.

In step 412, the method starts by receiving a sign-up/login from a user for the intelligent calendar application and then connecting to the user's intelligent calendar once logged in. If the user has an account, the user just needs to log in, and the intelligent calendar application may automatically connect with the user's intelligent calendar.

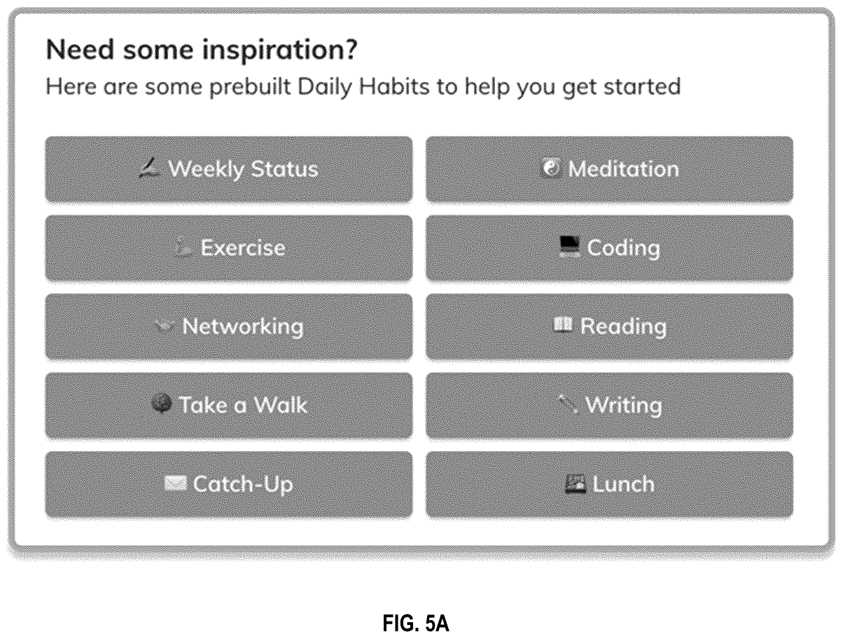

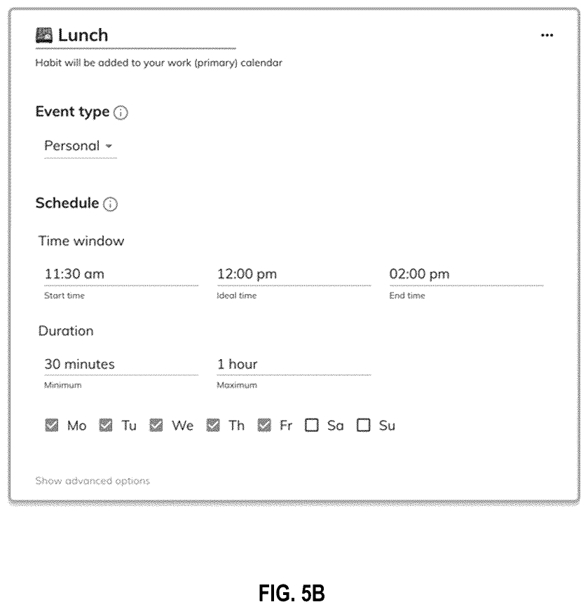

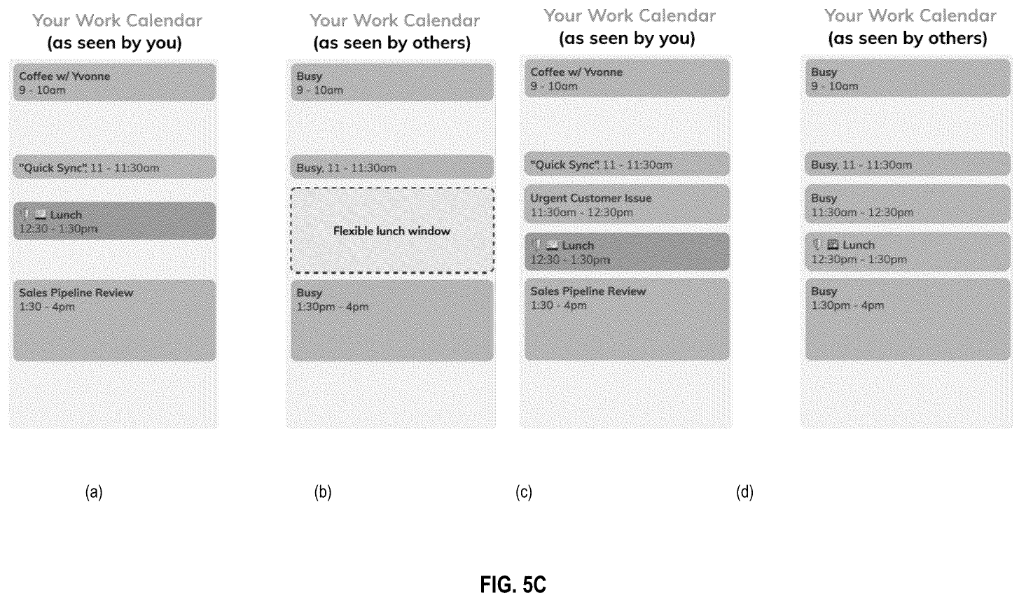

In step 414, the intelligent calendar application provides a list of prebuilt habits to the user. As illustrated in FIG. 5A, the list of prebuilt habits may be provided through a user interface with multiple habit links, which include, but are not limited to, weekly status, mediation, exercise, coding, networking, reading, taking a walk, writing, catch-up, and lunch. To make time for lunch, the user may select the “lunch” link in the user interface, which then triggers a generation of another user interface for the user to create the lunch schedule, as illustrated in FIG. 5B.

In step 416, the intelligent calendar application receives user input to customize the lunch schedule. As illustrated in FIG. 5B, the intelligent calendar application may include certain default settings. For example, the event type is set to personal by default, and the time window to eat is set to between 11:30 am and 2 pm with a flexible length between 30 min to 1 hour from Monday to Friday. The user may leave the default settings as is or customize the settings to whatever eating schedule s/he wants. For example, the user may dynamically adjust the duration of a lunch event on the calendar based on how much of a window the user has to get it done. The user may choose 30 min, 40 min, 45, min, or 1 hour based on a customized user input. If the user needs an event duration to be less than 30 min or more than an hour, the intelligent calendar application disclosed herein may also offer such flexibility.

It should be noted that such flexibility is not limited to the habit creation described herein, but rather can be applied to any other event to be placed or already placed on a calendar. For example, the intelligent calendar application disclosed herein may allow a user to dynamically adjust the duration for any event to be placed or already placed on a calendar based on how much of a window the user hopes to get the event done or based on certain other factors, such as the priority of the event. For example, if the user thinks that the event has a higher priority, even if the event is expected to last 45 min, the user may increase the flexibility by dynamically adjusting the duration to be 1 hour or even longer.

In step 418, the intelligent calendar application automatically blocks an intelligent, flexible lunch schedule on the calendar of the user. For example, the intelligent calendar application may automatically block 12:00-12:30 pm on the calendar of the user for lunch if this time slot is available. If this time slot is not available, the intelligent calendar application may block 11:30 am-12:00 μm or 12:30-13:00 pm if they are available. If not, the next best time slot is selected by the intelligent calendar application.

It is to be noted that the above selected time slot for lunch is flexible, which means that the selected time slot may be further adjusted automatically if there is another habit or task that has a higher priority than lunch.

FIG. 5C shows an example of automatic adjustment of a scheduled lunch. In Part (a) of FIG. 5C, a user's lunch was originally scheduled at 12:30-1:30 pm and was shown as “lunch” in the work calendar of the user when viewed by the user. Meanwhile, since the lunch has a low priority and can be flexibly scheduled between the user's available time window between 11:30 am-13:30 pm, the user's work calendar showed others that there is a “flexible lunch window” between 11:30 am-13:30 pm, as can be seen from Part (b) of FIG. 5C. This then allows others viewing the calendar to have a chance to schedule an event during the flexible lunch window. For instance, if another event with a high priority needs to be scheduled, the high-priority event can be scheduled in the flexible lunch window. Part (c) of FIG. 5C shows that an “urgent customer issue” was scheduled in the flexible lunch window. As can be seen, since the event “urgent customer issue” has a higher priority, it was scheduled to a time slot as desired, e.g., between 11:30 am-12:30 pm. Since the lunch has a lower priority, it was then atomically moved to another time slot, e.g., between 12:30-13:30 pm as can be seen in Part (c) of FIG. 5C. To improve the privacy, this event “urgent customer issue” was shown as “busy” to others, as can be seen from Part (d) of FIG. 5C.

It is to be noted that the above-described method 400 is not limited to lunch scheduling, but may be applied to any other habit scheduling. For example, the described process 410 may be also applied to schedule reading, writing, taking a walk, or any other habit. In FIG. 5A, the “coding” link may allow a user to add any other habit s/he wants to his/her calendar.

### 2. Make Time for Tasks

Scheduling 1:1 meetings (or 1:1s) becomes a standard practice after the pandemic but can be quite challenging and time-consuming under certain circumstances. For example, if a user is juggling multiple 1:1 meetings with direct reports, managers, fellow team members, or even external partners or clients, it is likely the user is also spending a fair amount of time rescheduling and canceling a lot of meetings every week. For example, a user may have to prioritize other work items or meetings or simply don't have enough agenda items to justify a meeting that week. In real applications, a large number of meetings (e.g., more than 40% of 1:1 meetings) are rescheduled. While some existing calendar or event organization platforms support basic “recurring events” for 1:1 meetings, it doesn't offer much automation around rescheduling. Therefore, if a user gets overbooked, is unavailable that week, or if the user just wants to push it back, the other existing calendars or event organization platforms do not account for these scenarios, and thus a user may end up spending over 10 minutes coordinating a new meeting time slot every time the user needs to reschedule, which is time-consuming and not efficient.

The intelligent calendar application disclosed herein may be configured to fully automate finding the best time for both attendees across two busy calendars, but also auto-reschedule to the next best time if a conflict comes up. Recurring 1:1s can also get scheduled and rescheduled within the meeting hours a user sets through a user interface. In some embodiments, a user can even customize preferred meeting hours for each of the user's 1:1s. In some embodiments, the intelligent calendar application may also reference invitees' set meeting hours to find the best time for both, and adapt to any changes in either of the schedules associated with the user and invitees.

In the age of remote work, this feature is especially useful for streamlining meeting times in a dispersed team, especially when a user has to find mutual availability across time zones. In some embodiments, the intelligent calendar application can also add third-party (e.g., Zoom, Google Meets) calls, and attach agendas and files to share, so the user has everything s/he needs right in the calendar event.

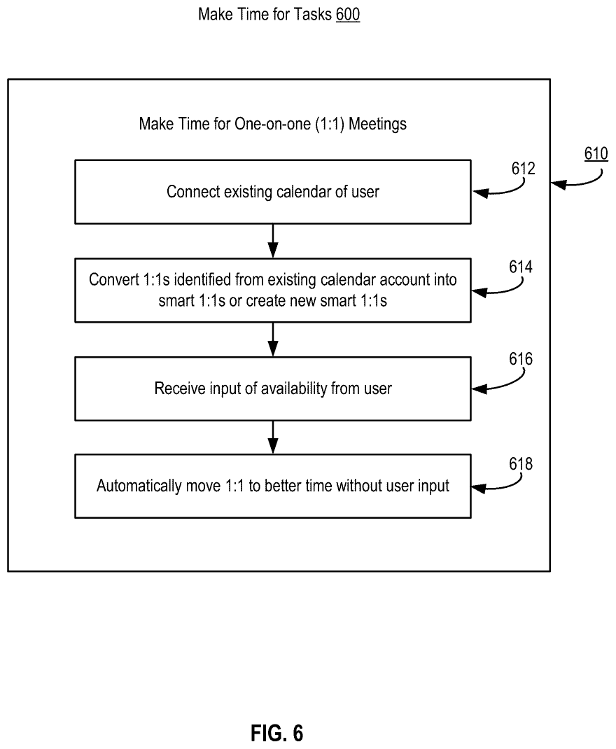

The intelligent calendar application makes it a super easy transition to smart 1:1s by detecting all of a user's existing 1:1 meetings, and gives the user the option to automatically convert them using the existing event details as defaults. A specific process for intelligent scheduling of smart 1:1s is further described with reference to FIG. 6.

FIG. 6 is a flow chart of an example method 600 for creating a task, according to some embodiments. As illustrated, the method 600 for creating a task is illustrated with reference to a process 610 of making time for 1:1 meetings for a user.

In step 612, the intelligent calendar application connects to the existing calendar(s) of the user. The existing calendar can be an intelligent calendar created by the intelligent calendar application or other calendars (e.g., Google Calendar) that includes an integrated intelligent calendar application. By connecting to the existing calendar(s), the intelligent calendar application makes sure that 1:1 meetings are always scheduled around other calendar events.

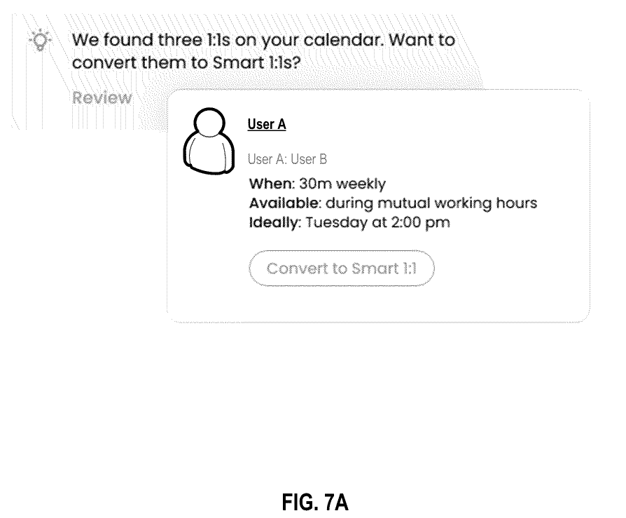

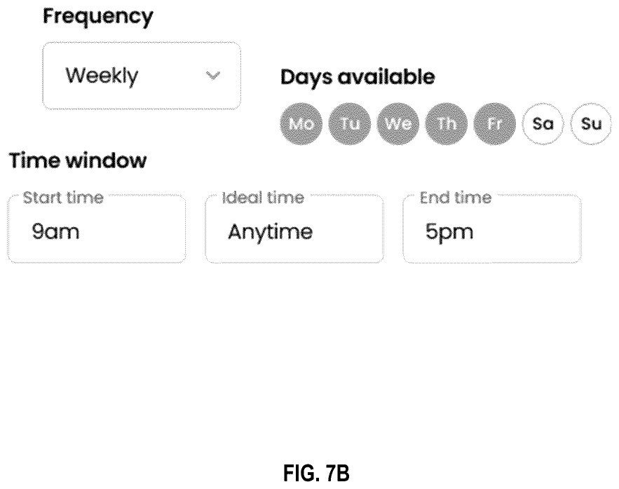

In step 614, the intelligent calendar application converts existing direct report, cross-functional, and ship-level one-to-ones to smart 1:1s in a single click. FIG. 7A illustrates an example of a direct report, cross-functional, and ship-level one-to-one meeting, among three 1:1s found in the user's calendar (e.g., Google Calendar). To convert the found 1:1s, the user just needs to click “convert to smart 1:1” without additional effort, the intelligent calendar application will automatically convert the meeting to smart 1:1 and spin up a new meeting. In practical applications, the user may further customize the frequency, and add description links, notes, and Zoom or Google Meet links for remote calls.

In step 616, the intelligent calendar application may receive user input to set up meeting hours and an ideal time. One example user interface for setting up the parameters is illustrated in FIG. 7B. As can be seen from the figure, the user interface allows the user to customize the frequency, the available days, and the time window including the start time, ideal time, and end time for the smart 1:1 meetings. To schedule the 1:1 meetings, the intelligent calendar application may further collect the attendee's availability as well, so the user's smart 1:1s are always scheduled during the mutually available time.

In step 618, the intelligent calendar application automatically blocks intelligent, flexible events on the calendars of the users for the 1:1 meetings. For example, the intelligent calendar application may automatically block a time slot at or close to the ideal time. If one of the attendees responds with “No”, “000”, “OPT”, or other kinds of declination, the intelligent calendar application may automatically move a 1:1 meeting to the next best available time in the specified time window for the user without requiring the user to further email the attendee to manually reschedule the 1:1 meeting. This greatly saves the network bandwidth and computing resources of the client device in scheduling the 1:1 meetings, thereby improving the overall performance of the client device.

It is to be noted that the above-described method 600 is not limited to 1:1 meeting scheduling, but can be applied to other different task or event scheduling. For example, the described process 610 may be also applied to schedule a conference room, medical device, personal training, etc.

### 3. Keep Calendars in Sync

In some calendar or event organization platforms (e.g., Google Calendar), there are two types of calendars: primary calendar (or work calendar) and secondary calendar (or personal calendar). A user's primary calendar is the calendar where all the action happens: anytime someone goes to schedule time with the user, they'll be looking at the user's primary calendar. Secondary calendars are really just calendars the user can share with the user's own account (e.g., the user's Google account), which is useful if the user wants to see multiple schedules overlaid on one another. But no one else can see the user's own account and thus events from a secondary calendar of the user will not be reflected on the user's primary calendar. This causes certain problems. For example, if the user has a doctor's appointment on the user's secondary calendar and wants this time blocked out so others don't overbook it on the user's primary work calendar, the user may have three unsavory options if following other existing calendar or event organization platforms: 1) Invite the user's work email to the personal events: this is challenging in privacy protection since the user now has a personal event sitting on the user's work calendar for all to see. 2) Create a copy of the appointment on the user's work calendar: this is hard to maintain because now the user has to frequently check to keep the copy up-to-date with the original event. 3) Share the user's entire personal calendar with people in the user's organization: this may allow others to see the user's calendar (and all its private details). In addition, the others may still not see the user's personal events when using find-a-time feature in these existing calendar or event organization platforms.

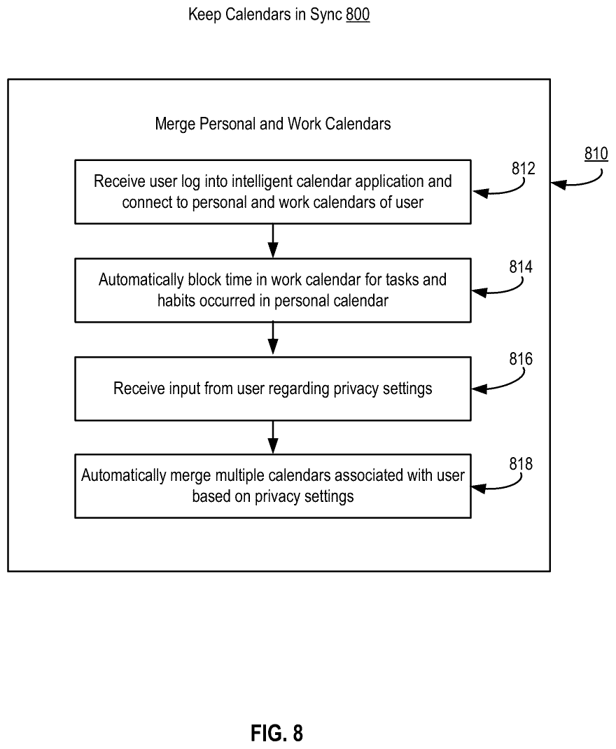

The intelligent calendar application disclosed herein addresses this kind of problem by using a calendar sync function, which allows a user to block events across calendars, keeping the user's synced events up-to-date anytime there is a change. The calendar sync function also solves the “privacy problem” by allowing the user to set customizable visibility for the synced events. For example, if the user has a job interview that the user does not want people spying on, the user may just set it as “busy” or “personal commitment.” This then provides an effective way to offer just the right amount of context without worrying about people seeing details the user doesn't want them to. Another advantage of using the calendar sync function is that the user can completely eliminate the organization's visibility of the user's other calendars without having to worry about being overbooked. A specific process for intelligent calendar synchronization is further described with reference to FIG. 8.

FIG. 8 is a flow chart of an example method 800 for keeping calendars in sync, according to some embodiments. As illustrated, the method 800 for calendar sync is illustrated with reference to a process 810 of merging a user's personal and work calendars.

In step 812, the intelligent calendar application receives a user's log into the application. The user may have two different calendars, a personal calendar, and a work calendar. The intelligent calendar application then connects to the two different calendars.

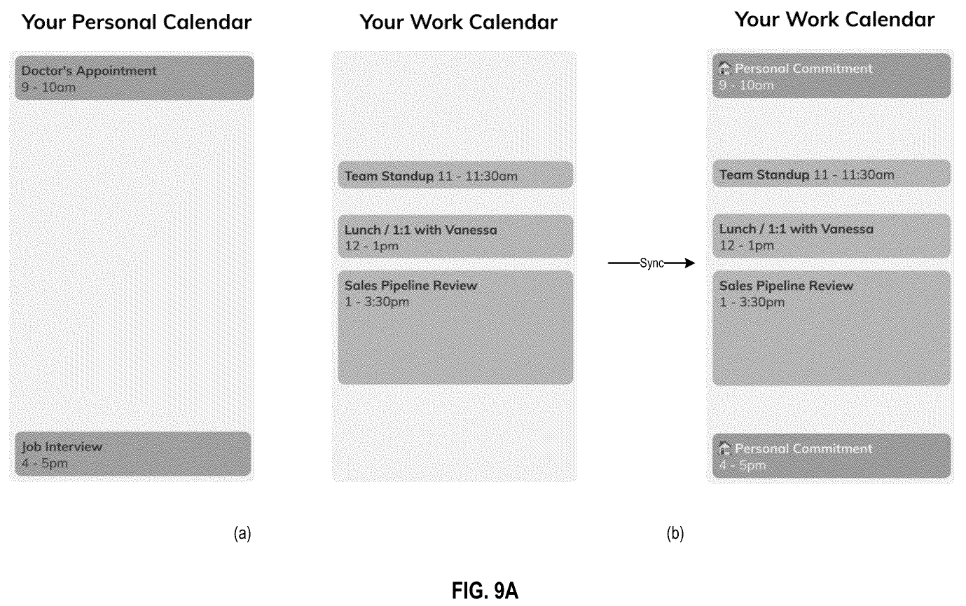

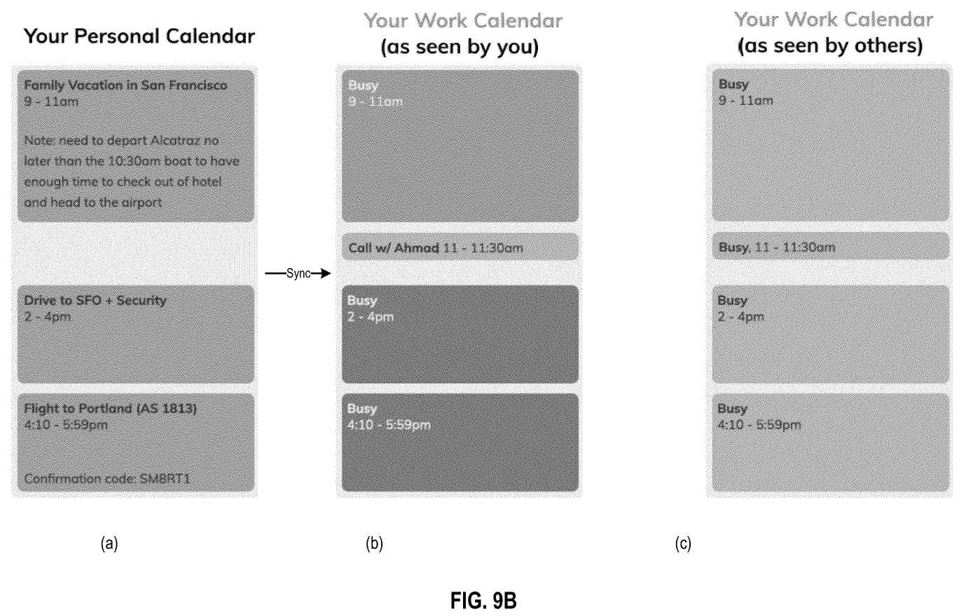

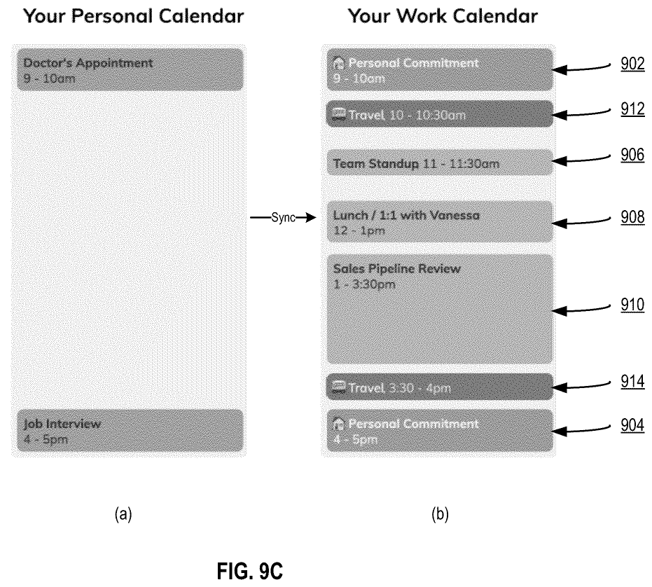

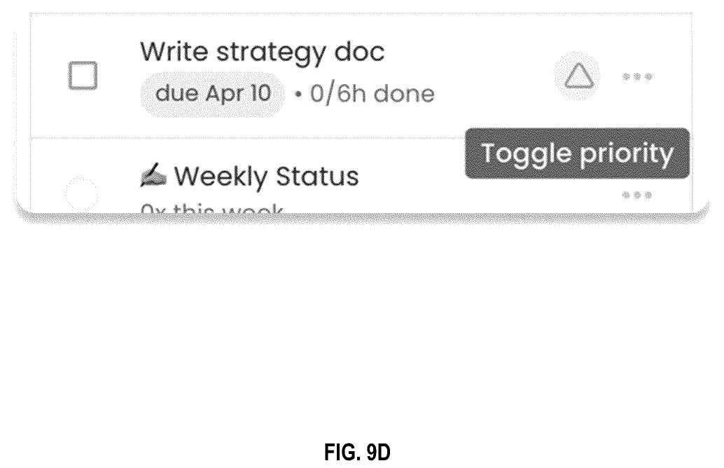

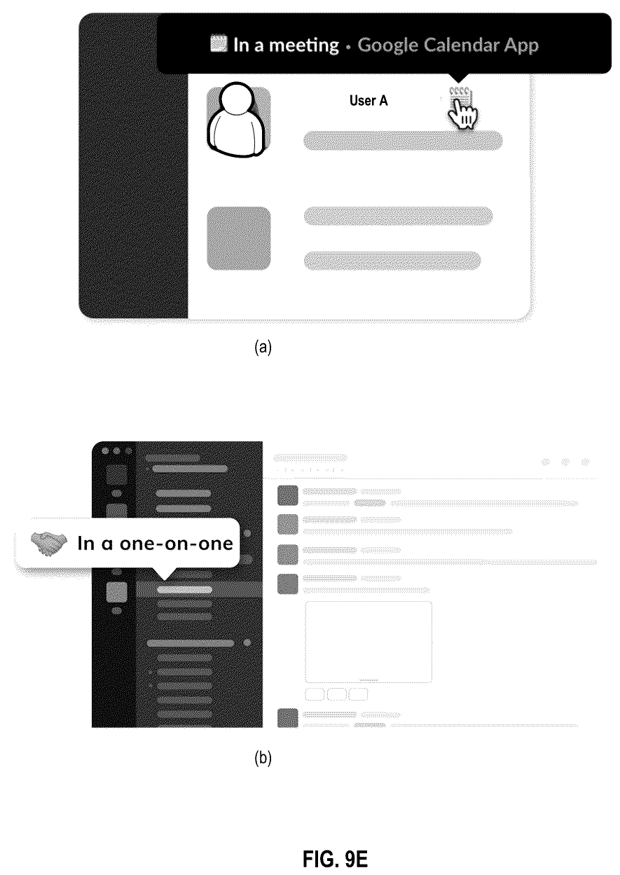

In step 814, the intelligent calendar application automatically blocks time in the work calendar for the events and tasks that occurred in the personal calendar. Part (a) of FIG. 9A illustrates a personal calendar and work calendar of a user before the calendar synchronization. As can be seen, there are two tasks in the personal calendar of the user, i.e., a doctor's appointment at 9-10 am and a job interview at 4-5 μm. In the work calendar, there are three events, i.e., team standup at 11:00-11:30 am, lunch/1:1 with Vanessa at 12:00-13:00 μm, and sales pipeline review at 13:00-15:30 pm. After the user logs into the intelligent calendar application, the application may connect to the personal calendar and work calendar of the user. The intelligent calendar application then automatically blocks time on the work calendar for the events or tasks that occurred in the personal calendar, as shown in Part (b) of FIG. 9A, where the two new tasks occur in the work calendar. The time slots for the two tasks or events map to the time slots of the two tasks or events in the personal calendar. It is to be noted that FIG. 9A just shows the synchronized events or tasks in the work calendar. In real applications, the personal calendar may be also synchronized, in which the tasks or events originally occurred in the work calendar may also occur in the personal calendar.

In step 816, the intelligent calendar application may receive user input for setting the privacy of the tasks or events. That is, during the synchronization process, the tasks or events may be set to different levels of privacy, from “busy” to the full details of the events or tasks. In this way, the user can expose just as much or as little of his/her calendar to others as the user would like. For example, in FIG. 9A, the detailed information of the two events in the original personal calendar is not shown in the synchronized work calendar. Instead, the two events are shown as “personal commitment” in the synchronized work calendar.

FIG. 9B shows another example of work calendar and personal calendar synchronization. Part (a) of FIG. 9B shows a personal calendar before synchronization. In the personal calendar, there are three events, each of which shows detailed information about the event. Part (b) of FIG. 9B shows a work calendar after calendar synchronization. As can be seen, after the events in the personal calendar were synchronized to the work calendar, the three events that originated from the personal calendar do not show detailed information of the three events. Instead, these events are shown as “busy” in the synchronized work calendar. That is, during the synchronized process, the detailed information of personal events was hidden and thus is not displayed to others after calendar synchronization. In addition, as can be seen in Part (b) and Part (c), a synchronized work calendar may show different content when viewed by the user himself/herself or when viewed by others. When the synchronized work calendar is viewed by the user, the detailed information for the event “Call w/Ahmad” is shown to the user, as can be seen in Part (b) of the FIG. 9B. On the other hand, when viewed by others, the synchronized work calendar does not show detailed information about the event. Instead, the event is merely shown as “busy” as can be seen from Part (C) of FIG. 9B.

Referring back to FIG. 8, after receiving the privacy setting from the user, the intelligent calendar application may automatically merge or synchronize the work and personal calendars of the user at step 818. The displayed information of the synchronized work and personal calendars may vary and depend on the privacy settings defined by the user and depend on who will view the calendar, as can be seen from Part (b) of FIG. 9A and Part (b) and Part (c) of FIG. 9B.

It is to be noted that the above-described method 800 is not limited to the calendar synchronization or calendar merge, it can also be applied to the event integration for the events from other event organization platforms. FIG. 9C shows an example work calendar that is obtained from both calendar synchronization and event integration. Part (a) of FIG. 9C shows a personal calendar of a user before synchronization and event integration. Part (b) of FIG. 9C shows a synchronized and integrated work calendar of the user. In the work calendar in Part (b) of FIG. 9C, events 902 and 904 are synchronized events from the personal calendar shown in Part (a) of FIG. 9C, and events 906, 908, and 910 are the events from the original work calendar. Events 912 and 914 that occurred in the current work calendar are not from the original personal calendar or work calendar. Instead, the two events originated from the events that occurred in Slack. That is, the two events 912 and 914 originated from the integrated event organization platform.

It is also to be noted that some of the steps in the above-described method 400, 600, or 800 may be optional. Further, some of the steps may be performed simultaneously, or in a different order than that shown in FIG. 4, FIG. 6, or FIG. 8.

### 4. Improve Workweek Flexibility

If a user's whole workweek is blocked out, it is really difficult for others to find time to meet with the user. This can often lead to even more work on a user's plate. For example, the user may get a message that looks something like this: Your calendar looks pretty crazy for the next week. Could I get 30 min to sync up with you? Or the user may get an email like this: Wondering if you can get 30 min of your time this week. Your calendar looks a bit slammed so just wanted to see if we could move something around to get a few moments to sync up. When getting a message or email like this, the user may begin to think about which events to sacrifice, and how it might impact the overall schedule.

In existing calendar or event organization platforms, events are not all created equal. For example, there are some events that can be seen as blocked only by an authorized user, but won't be seen as blocked by others. These events are known as “free events”, and they can be a really powerful way to add events to a user's calendar without impacting availability.

But in practice, a user can't really put free events to work without a lot of manual work. For example, if a user adds a free event to the user's calendar, and it gets overbooked, now the user has to worry about finding another place on the user's schedule to accomplish it.

The intelligent calendar application disclosed herein can add these free events automatically. As the intelligent calendar application blocks time on a user's calendar for the user's habits, tasks, and smart 1:1 meetings, it looks at the user's schedule to see how busy the user is. If the user has a lot of Slack activities in the user's schedule, the intelligent calendar application will initially add those events to the user's calendar as free events, which means that the user can see these events but others won't. As the user's schedule fills up and the intelligent calendar application senses that the user is running out of time to get things done, the application automatically flips those events to “busy”, so that these events block out a user's availability. This can then prevent a user from being overbooked or the user's calendar becomes too full.

### 5. Easy Calendar Audit

Calendar audits are ideally the kind of thing a user should be able to do each week, but it is often just too labor-intensive to do frequently. Even when a user performs an infrequent calendar audit, getting accurate data can be challenging unless the user is a Google Scripts wizard and wants to worry about cleaning and parsing the calendar data.

The intelligent calendar application disclosed herein gives a user two powerful ways to audit his/her calendar. First, it gives a user weekly statistics on where his/her time is going across different categories. Second, a user can look at how his/her time is broken down alongside his/her calendar, and even filter individual classes of events out to see, for example, how much time the user is spending in group meetings.

A user can make better decisions about his/her schedule when the user has data, and the intelligent calendar application disclosed herein makes it easier to get the information a user needs.

### 6. Integrate Tasks into Calendar

Google Tasks is a great feature in Google Calendar. It is a simple to-do list that lives right alongside a user's schedule. But Google Tasks doesn't really block time on the user's calendar, and thus no blocked times for these tasks are shown to others when they view the user's calendar. Google Tasks looks more like a friendly reminder, which isn't that helpful when a user actually needs the time to get stuff done.

In addition, when a user sets a due date for a task in Google Tasks, that due date is treated as “the date the event will be scheduled,” which is also unhelpful if the user needs the time to complete the task before the due date. If the user needs 8 hours to write a document, it is not very good to have a reminder on his/her calendar on the day of the due date, especially when the day is already overbooked.

The disclosed intelligent calendar application can be configured to integrate natively with Google Tasks (along with Todoist, Jira, Linear, Asana, and the like) through the task feature of the application, so as to automatically sync a user's task into his/her calendar, and actually blocking the time for the user to get the task completed before it is due. In addition, just like any other task created through the intelligent calendar application, the synchronized task can also reschedule and toggle between free and busy as the user's schedule changes.

### 7. Reprioritize Entries in Calendar

In real applications, even if a user has set out a great plan for his/her week and blocked it all on his/her calendar, things happen and it is not uncommon for his/her priorities to shift around. This often means a user has to rejigger his/her whole schedule to get things back on track. Such kind of task or event reprioritization is not commonly explored or very difficult to implement in existing calendars and event organization platforms.

In the disclosed intelligent calendar application, reprioritization is as easy as a single click. For example, if a user has decided that “customer support emergency response” is more important than “write that important strategy doc,” even if the strategy doc is due sooner, a user can just click “toggle priority” as shown in FIG. 9D, to change the priority of an event or task as expected, which then causes certain events rescheduled due to the changed priorities.

### 8. Keep Slack Status in Sync

Slack has a Google Calendar integration that can update a user's Slack status to show when the user is busy with an event. But again, this is where things are just a bit too all-or-nothing: the whole purpose of updating a user's Slack status is to help others know when the user is truly busy and shouldn't be disturbed, or when the user can afford to be interrupted. But in this case, the integration only shows one status: “In a Meeting”, as can be seen from Part (a) of FIG. 9E.

This is a bit undesirable if the user really wants his/her Slack status to stay synced with his/her schedule. That is, the user may not want people to think s/he is constantly in meetings, while at the same time it would be great to make sure that the user doesn't get bugged when the user is headed down on important work or meeting with customers.

The disclosed intelligent calendar application can help to bring a bit more power to the user's Slack status. Not only can the user manage his/her entire schedule from Slack using the integration of the intelligent calendar application as previously described, but the user can also synchronize his/her status to different categories of events that the intelligent calendar application automatically detects on the user's calendar. Part (b) of FIG. 9E shows an example display of identified category of the event, which is displayed in the Slack status and provides more information about the user's current status. Moreover, a user may set “Do Not Disturb” for certain categories of events and customize the message shown to others. This then provides more valuable information about the user's status in Slack, where distractions can be high in supply.

### 9. Schedule Events Based on Priority

As described earlier, in some embodiments, the priority information for an event may be automatically determined and/or user-defined. The intelligent calendar system disclosed herein may then schedule the events by exploring the priority information associated with events.

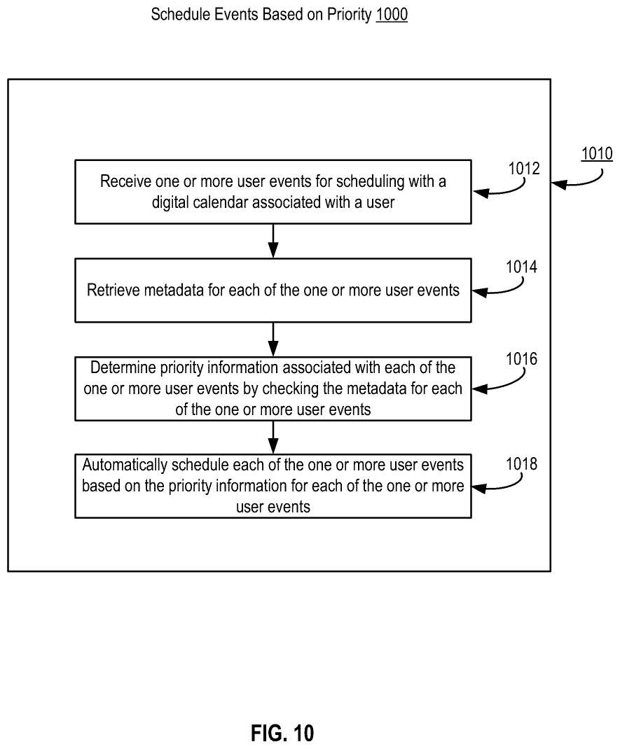

FIG. 10 is a flow chart of an example method 1000 for scheduling one or more events based on priority information of the events, according to some embodiments. As illustrated, the method 1000 for priority-based event scheduling is illustrated with reference to a specific process 1010.

Briefly, in step 1012, one or more user events are received for scheduling with a digital calendar associated with a user. In step 1014, metadata for each of the one or more user events may be retrieved. In step 1016, priority information associated with each of the one or more user events may be determined by checking the metadata for each of the one or more user events. In step 1018, each of the one or more user events may be automatically scheduled (e.g., by the intelligent calendar system 100) based on the priority information for each of the one or more user events.

In some embodiments, the priority information associated with each of the one or more user events is defined through metadata for each of the one or more user events when a user event is created for scheduling.

In some embodiments, the priority information defined through metadata for an event includes an indication of whether the event is under the control of a scheduling application for automatic scheduling by the scheduling application. In some embodiments, when an event is under the control of a scheduling application for automatic scheduling by the scheduling application, the priority information defined through metadata includes an indication of a specific vendor of the scheduling application for controlling the automatic scheduling of the event. In some embodiments, the priority information defined through metadata for an event includes an indication of whether the event is able to move during a scheduling process. In some embodiments, the priority information defined through metadata for an event includes an indication of the priority level of the event. In some embodiments, the priority information defined through metadata for an event includes an indication of a priority sublevel of the event.

In some embodiments, an ID for each of the one or more user events is further generated, where the user ID, when decoded, indicates the priority information associated with each of the one or more user events.

In some embodiments, one or more scheduling links are further generated for sharing information associated with the digital calendar. In some embodiments, one or more high priority scheduling links are further generated for scheduling one or more events with a high priority. In some embodiments, the one or more high priority scheduling links include one or more team high priority scheduling links.

In some embodiments, a system for implementing the above described methods are further provided. The system may include a processor and a memory, coupled to the processor, configured to store executable instructions that, when executed by the processor, cause the processor to implement the above described methods.

In some embodiments, a computer program product for implementing the above described methods are further provided. The computer program product includes a non-transitory computer-readable medium having computer-readable program code stored thereon. The computer-readable program code is configured to implement the above descried methods.

It is to be noted that the above described exemplary embodiments are not for limitations. The disclosed intelligent calendar application may have other features or functions not described above. For example, the disclosed intelligent calendar application may allow a user to manage all calendars from one place, add a secondary time zone to a calendar, let others to manage events in a calendar, etc. These different features and the above described other features and advantages of the intelligent calendar application together improve the performance of the calendar management on a client device, thereby greatly improving the functionalities of the client device.

The phraseology and terminology used herein are for the purpose of description and should not be regarded as limiting. The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for intelligent calendar management, the system comprising:
a processor; and
a memory, coupled to the processor, configured to store executable instructions that, when executed by the processor, cause the processor to:
receive one or more user events for scheduling with a digital calendar associated with a user;
retrieve metadata for each of the one or more user events;
determine priority information associated with each of the one or more user events by checking the metadata for each of the one or more user events; and
automatically schedule each of the one or more user events based on the priority information for each of the one or more user events.

2. The system of claim 1, wherein the priority information associated with each of the one or more user events is defined through metadata for each of the one or more user events when a user event is created for scheduling.

3. The system of claim 1, wherein the priority information defined through metadata for an event includes an indication of whether the event is under a control of a scheduling application for automatic scheduling by the scheduling application.

4. The system of claim 3, wherein, when the event is under the control of a scheduling application for automatic scheduling by the scheduling application, the priority information defined through metadata includes an indication of a specific vendor of the scheduling application for controlling the automatic scheduling of the event.

5. The system of claim 1, wherein the priority information defined through metadata for an event includes an indication of whether the event is able to move during a scheduling process.

6. The system of claim 1, wherein the priority information defined through metadata for an event includes an indication of a priority level of the event.

7. The system of claim 6, wherein the priority information defined through metadata for an event includes an indication of a priority sublevel of the event.

8. The system of claim 1, wherein, the executable instructions further include instructions that, when executed by the processor, cause the processor to:
generate an ID for each of the one or more user events, wherein the user ID, when decoded, indicates the priority information associated with each of the one or more user events.

9. The system of claim 1, wherein, the executable instructions further include instructions that, when executed by the processor, cause the processor to:
generate one or more scheduling links for sharing information associated with the digital calendar.

10. The system of claim 1, wherein, the executable instructions further include instructions that, when executed by the processor, cause the processor to:
generate one or more high priority scheduling links for scheduling one or more events with a high priority.

11. The system of claim 1, wherein the one or more high priority scheduling links include one or more team high priority scheduling links.

12. A method for intelligent calendar management, the method comprising:
receiving one or more user events for scheduling with a digital calendar associated with a user;
retrieving metadata for each of the one or more user events;
determining priority information associated with each of the one or more user events by checking the metadata for each of the one or more user events; and
automatically scheduling each of the one or more user events based on the priority information for each of the one or more user events.

13. The method of claim 12, wherein the priority information associated with each of the one or more user events is defined through metadata for each of the one or more user events when a user event is created for scheduling.

14. The method of claim 12, wherein the priority information defined through metadata for an event includes an indication of whether the event is under a control of a scheduling application for automatic scheduling by the scheduling application.

15. The method of claim 14, wherein, when the event is under the control of a scheduling application for automatic scheduling by the scheduling application, the priority information defined through metadata includes an indication of a specific vendor of the scheduling application for controlling the automatic scheduling of the event.

16. The method of claim 12, wherein the priority information defined through metadata for an event includes an indication of whether the event is able to move during a scheduling process.

17. The method of claim 12, wherein the priority information defined through metadata for an event includes an indication of a priority level and a priority sublevel of the event.

18. The method of claim 12, further comprising:
generating an ID for each of the one or more user events, wherein the user ID, when decoded, indicates the priority information associated with each of the one or more user events.

19. The method of claim 12, further comprising:
generating one or more scheduling links for sharing information associated with the digital calendar.

20. A computer program product for intelligent calendar management, the computer program product comprising a non-transitory computer-readable medium having computer-readable program code stored thereon, the computer-readable program code configured to:
receive one or more user events for scheduling with a digital calendar associated with a user;
retrieve metadata for each of the one or more user events;
determine priority information associated with each of the one or more user events by checking the metadata for each of the one or more user events; and
automatically schedule each of the one or more user events based on the priority information for each of the one or more user events.
